(19) United States
(12) Patent Application Publication
(10) Pub. No.: US 2023/0058269 A1
(43) Pub. Date: Feb. 23, 2023

(54) APPARATUSES, COMPUTER-IMPLEMENTED METHODS, AND COMPUTER PROGRAM PRODUCTS FOR CONTINUOUS PERCEPTION DATA LEARNING

(71) Applicant: INTELLIGRATED HEADQUARTERS, LLC, Mason, OH (US)

(72) Inventors: Jagtar SINGH, Pittsburgh, PA (US); Thomas Henry EVANS, Morgantown, WV (US); Devesh Bilwakumar WALAWALKAR, Pittsburgh, PA (US); Mayank PATHAK, Pittsburgh, PA (US)

(21) Appl. No.: 17/408,142

(22) Filed: Aug. 20, 2021

(51) Int. Cl. G06N 20/00; H04L 12/24

(52) U.S. Cl. CPC G06N 20/00; H04L 41/16

(57) ABSTRACT

Embodiments of the present disclosure provide for improved model training and utilization. Embodiments of the present disclosure utilize high-fidelity data to train individual models across a plurality of computing devices, and utilize high-throughput communications networks (such as 5G communications networks) to enable continuous training of such models and/or central models based on the plurality of individual models (e.g., a federated centralized model optimized based on the individual models). Some embodiments provide the updated central model to one or more computing devices for use in processing further data and/or performing one or more subsequent tasks. In one context, individual AI robots embodying a fleet of AI-driven robots in a particular environment gather various sensor data for use in training updated individual models, and a central learning system aggregates over high-throughput communication network(s) each of the updated individual models to distribute an updated central model trained via a federated learning process.

### TECHNOLOGICAL FIELD

Embodiments of the present disclosure generally relate to improved training of data models, and specifically to improved training of individual models and a central model via use of high-throughput communications networks.

### BACKGROUND

In various circumstances, computing devices are configured to utilize particular models to perform any of a number of tasks. A particular computing device may gather and/or submit data for use in updating the models. Such models are often trained utilizing offline methodologies that batch collection of data, updating of the model, and redeployment of the updated models. In particular contexts, such as a warehouse environment, multiple computing devices may interact and maintain their own independent data models, such independent data models being utilized to subsequently perform offline updates of a single model that learns from each of the independent models and that can be redeployed on the individual computing devices. Applicant has discovered problems with current implementations for training of data models. Through applied effort, ingenuity, and innovation, Application has solved many of these identified problems by developing solutions embodied in the present disclosure, which are described in detail below.

### BRIEF SUMMARY

In general, embodiments of the present disclosure provided herein provide improved continuous perception data learning. Other implementations for providing improved perception data learning will be, or will become, apparent to one with skill in the art upon examination of the following figures and detailed description. It is intended that all such additional implementations be included within this description be within the scope of the disclosure, and be protected by the following claims.

In accordance with a first aspect of the present disclosure, a computer-implemented method is provided. An example computer-implemented method is provided for performing continuous, real-time learning from real-time sensor data providing perception of a particular environment. An example computer-implemented method may be performed by any one or more computing device(s), system(s), and/or the like embodied in hardware, software, firmware, and/or the like, as described herein. In some example embodiments of the example computer-implemented method, the example computer-implemented method includes receiving, at a first computing device, an environment perception data set associated with one or more real-time sensors. The example computer-implemented method additionally includes training, at the first computing device, an updated individual model based at least in part on the environment perception data set. The example computer-implemented method additionally includes transmitting, from the first computing device to a central learning system via at least one high-throughput communications network, the updated individual model to cause the real-time data central learning system to update a central model based at least in part on the updated individual model.

Additionally or alternatively, in some example embodiments of the example computer-implemented method, the first computing device receives the environment perception data set via the one or more high-throughput communications network.

Additionally or alternatively, in some example embodiments of the example computer-implemented method, the example computer-implemented method further includes receiving, at the first computing device from the real-time data central learning system, an updated central model trained based at least in part on the updated individual model and a plurality of other updated individual models associated with a plurality of other computing devices; and replacing the updated individual model with the updated central model.

Additionally or alternatively, in some example embodiments of the example computer-implemented method, the one or more real-time sensors comprises a real-time video sensor, a real-time image sensor, a real-time motion sensor, a real-time location sensor, or a combination thereof.

Additionally or alternatively, in some example embodiments of the example computer-implemented method, the example computer-implemented method further includes receiving, at the first computing device from the real-time data central learning system, an updated central model trained based at least in part on the updated individual model and a plurality of other updated individual models associated with a plurality of other computing devices; comparing first accuracy data associated with the updated individual model and second accuracy data associated with the updated central model to determine a preferred model representing the updated individual model or the updated central model; and applying a second environment perception data set to the preferred model.

Additionally or alternatively, in some example embodiments of the example computer-implemented method, the example computer-implemented method further includes transmitting error data objects associated with the training of the updated individual model to the real-time data central learning system.

Additionally or alternatively, in some example embodiments of the example computer-implemented method, the example computer-implemented method further includes the one or more real-time sensors are each embodied within the first computing device.

Additionally or alternatively, in some example embodiments of the example computer-implemented method, at least one of the one or more real-time sensors is external from the first computing device.

Additionally or alternatively, in some example embodiments of the example computer-implemented method, the updated individual model embodies a reinforcement learning model.

In accordance with a second aspect of the present disclosure, an apparatus is provided. An example apparatus is provided for performing continuous, real-time learning from real-time sensor data providing perception of a particular environment. An example apparatus in some embodiments includes at least one processor and at least one non-transitory memory having computer-coded instructions stored thereon. The computer-coded instructions, in execution with the at least one processor, configure the apparatus to perform any one of the example computer-implemented methods described herein. In another example embodiment of the example apparatus, the example apparatus includes means for performing each step of any one of the example computer-implemented methods described herein.

In accordance with a third aspect of the present disclosure, a computer program product is provided. An example computer program product is provided for performing continuous, real-time learning from real-time sensor data providing perception of a particular environment. An example computer program product includes at least one non-transitory computer-readable storage medium having computer program code stored thereon. The computer program code, in execution with at least one processor, configures the computer program product for performing any one of the example computer-implemented methods described herein.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates a block diagram of a system that may be specially configured within which embodiments of the present disclosure may operate;

FIG. 2A illustrates a block diagram of an example AI robot apparatus that may be specially configured in accordance with an example embodiment of the present disclosure;

FIG. 2B illustrates a block diagram of an example central learning apparatus that may be specially configured in accordance with an example embodiment of the present disclosure;

FIG. 3 illustrates an example visualization of a warehouse context for data collection and model training in accordance with at least some example embodiments of the present disclosure;

FIG. 4 illustrates example representations of data flow for model updating in accordance with at least some example embodiments of the present disclosure;

FIG. 5 illustrates an example representation of data flows for model updating based at least in part on a plurality of local models in accordance with at least some example embodiments of the present disclosure;

FIG. 6 illustrates an example representation of data flows for model updating based at least in part on error data objects in accordance with at least some example embodiments of the present disclosure;

FIG. 7 illustrates a flowchart depicting example operations of an example process for improved model training in accordance with at least some example embodiments of the present disclosure;

FIG. 8 illustrates a flowchart depicting example operations of an example process for replacing an updated individual model with an updated central model in accordance with at least some example embodiments of the present disclosure;

FIG. 9 illustrates a flowchart depicting example operations of an example process for setting a preferred model in accordance with at least some example embodiments of the present disclosure; and

FIG. 10 illustrates a flowchart depicting example operations of an example process for training and transmitting an updated central model in accordance with at least some example embodiments of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

### Overview

In several contexts, specially configured data models (e.g., artificial intelligence models, neural networks, machine learning models, and the like) are utilized in performing one or more particular tasks. For example, in one particular context, one or more robots implement such data models for perception and/or component manipulation, such as to identify particular objects and/or physically move particular objects within an environment. Accuracy of such data models is desirable to minimize errors resulting from use of such data models. In circumstances where these data models function inaccurately, the robots may fail the tasks in whole or in part due to the inaccurate operations of such data models. In the particular context of a warehouse environment, inaccurate operation of one or more data models may cause one or more robots to identify a wrong object, drop an object, move an object incorrectly, and/or the like.

In attempts to avoid these errors in operation, systems may attempt to keep such data models up-to-date and improving to reduce the likelihood of such errors. Conventional implementations, however, suffer from various problems associated with updating and improving such data models. Often, limitations on input data collection and transmission prevent continuous updating of such data models on the robots. Such problems are further exacerbated in circumstances where advanced model training mechanisms are implemented to further improve accuracy, for example use of federated learning through communication with a central system. In this regard, these implementations may further be unable to continuously perform training due to limitations on data collection and transmission of sensor data, models, additional data, and/or the like between the robots and a central system.

Embodiments of the present disclosure provide for various improvements in data model training and updating. In this regard, various embodiments described herein enable training of individual data models, and/or a central model aggregated therefrom, based on real-time and/or continuous communication of sensor data. Some embodiments of the present disclosure utilize a high-throughput communications network that enables continuous and/or real-time communication of high-bandwidth and/or high-fidelity data between various sensors and a particular robot, and/or between various robots and a centralized system. Such continuous data flow is usable to further train one or more data model(s) based on the real-time data flow, and/or can be used to redeploy updated data models similarly in real-time or near real-time. By reducing the latency involved in such training, updated data models may be generated and deployed quicker for use in performing tasks more accurately.

Embodiments of the present disclosure provide various technical advantages to various technical fields. For example, embodiments of the disclosure provide improvements to the technical field of improving data model accuracy by performing the particular steps described herein and utilizing the particular networking communications described herein in a manner that results in higher accuracy data models once trained. Additionally or alternatively, embodiments of the present disclosure provide improvements to performance of data model driven tasks by providing real-time (or near real-time) deployment of updated models to individual computing devices performing such tasks (e.g., robots within a particular environment). Additionally or alternatively, embodiments provide technical improvements to the technical field of improved data management and model training by enabling storage of continuously collected, high-fidelity and/or high-bandwidth sensor data that enables real-time updating of data model(s), subsequent training of data models based on such high-fidelity stored data, and/or any other subsequent processes involving such stored data. Additionally or alternatively still, embodiments of the present disclosure advantageously utilize particular network communication techniques and mechanisms in a unique manner.

### Definitions

The term “real-time” refers to capture and/or communication of data between computing devices in a sufficiently short period of time to enable continuous transmission of such data between the computing devices. In some embodiments, real-time refers to transmission of high-fidelity sensor data from a first computing device to a second computing device within milliseconds or within a second.

The term “computing device” refers to hardware, software, firmware, and/or a combination thereof, that stores and/or processes data. In some embodiments, a computing device includes hardware, software, firmware, and/or a combination thereof, that performs particular desired functionality associated with the computing device.

The term “AI robot” refers to any number of computing device(s) that maintain and/or utilize one or more machine learning, algorithmic, and/or statistical model(s) for performing one or more task operation(s) utilizing any number of trained model(s). In some embodiments, an AI robot includes and/or maintains one or more specially configured artificial intelligence model(s) that generate results determining operation(s) to be initiated for controlling one or more aspects of the AI robot. In some embodiments, an AI robot includes one or more arm(s), grip(s), and/or other physical component(s) controlled by the AI robot that enable interaction with an environment surrounding the AI robot.

The term “high-throughput communications network” refers to one or more high-capacity, high-throughput, and low latency communications network(s) established to enable communication between two or more computing devices. Non-limiting examples of a high-throughput communications network include a fifth generation (“5G”) cellular communications network and a Wi-Fi 6 enabled communications network satisfying the IEEE 802.11ax standard. A high-throughput communications network is configured with high bandwidth and low latency to enable consistent and/or continuous real-time communication of high fidelity data transmissions, such as image transmissions, video transmissions, and/or other continuous data.

The term “real-time sensor” refers to hardware, software, firmware, and/or a combination thereof, that captures a particular type of data associated with a particular environment. A real-time sensor is capable of transmitting captured sensor data to one or more directly connected computing devices for processing, and/or to access a high-throughput communications network for transmitting such captured sensor data to one or more remote computing device(s). In some embodiments, a real-time sensor may include a single computing device or any number of computing devices communicable with one another. Non-limiting examples of a real-time sensor include an image sensor (e.g., an image camera), a video sensor (e.g., a video camera), a LiDAR sensor, a motion sensor, a location sensor, an RFID reader, and a range sensor.

The term “mobile” when used with respect to a computing device refers to a computing device that can be repositioned to a new location within a particular environment. In some embodiments, a mobile computing device is embodied within and/or as a sub-component of another mobile computing device within the environment, for example a mobile AI robot including mobile real-time sensor(s).

The term “fixed” when used with respect to a computing device refers to a computing device that is fixed at a static position, rotation, and/or orientation within a particular environment. A fixed real-time sensor, for example, represents a real-time sensor that is permanently or temporarily affixed at a particular location within an environment.

The terms “sensor data” and “real-time sensor data” refer to data captured by a real-time sensor that represents one or more aspects of an environment and is transmittable via a high-throughput communications network in real-time or near-real-time (e.g., within a time interval sufficient to enable continuous transmission of said data).

The term “data type” refers to a categorization or data encoding of sensor data. In some embodiments, a data type for particular sensor data is based on a real-time sensor that captured such sensor data.

The term “environment perception data set” refers to one or more electronically managed data objects that represent and/or include one or more portion(s) of sensor data associated with at least a portion of an environment. In some embodiments, an environment perception data set associated with a particular AI robot includes sensor data captured and/or aggregated from real-time sensor(s) onboard the AI robot or real-time sensor(s) communicable with the AI robot.

The term “task operation” refers to particular action(s) to be performed by one or more AI robot(s) within a particular environment by interaction between the AI robot and at least a portion of the environment. Non-limiting examples of a task operation include a picking operation to be performed automatically by one or more AI robot(s) within an environment. In some embodiments, a task operation includes one or more data-driven action(s) indicating performance of a particular action, including without limitation scanning of a machine-readable label (e.g., a barcode, QR code, and/or the like) on a particular item, relocating a particular item through one or more sensor(s) to another location, and/or picking an item from a current location and depositing it in another location for confirmation of the identity of the item and/or further processing of the item by another system. In some embodiments, a task operation includes or is associated with target location data embodying the location at which the task operation is performable.

The term “environment” refers to a defined physical area within which one or more computing devices, AI robots, human actors, and/or other entities operate to perform one more task operations. In some embodiments, an environment includes one or more real-time sensors for capturing real-time sensor data associated with a defined physical area monitored by each of the real-time sensors.

The term “historical data” refers to previously stored data associated with an environment, sensor data of previous environment perception data set(s), item(s) in the environment, and/or the like, that are maintained by one or more computing device(s) for processing during one or more subsequent timestamps. Non-limiting examples of historical data includes real-time sensor data captured at a previous timestamp, data embodying results of determination(s) made from previously captured real-time sensor data, error(s) detected from operation(s) and/or results of model(s), and/or task operation(s) performed or to be performed by an AI robot, and stored for processing at a subsequent timestamp in one or more data repositories.

The term “real-time location sensor” refers to a particular real-time sensor that captures location data indicating the location of the real-time sensor within a particular environment or the location of detected object(s) within the environment. Non-limiting examples of a location sensor include GPS or other coordinate tracking chips, localized location tracking devices, RFID scanners at a known position, and/or the like. The term “real-time location data” refers to high-fidelity location data transmittable continuously or near-continuously over a high-throughput communications network.

The term “real-time video sensor” refers to a real-time sensor that captures real-time video data representing the environment, wherein the real-time video data embodies any number of frames of image data. Non-limiting examples of a real-time video sensor include color video cameras, CCTV cameras, and high-resolution sensors. The term “real-time video data” refers to high-fidelity video data transmittable continuously or near-continuously over a high-throughput communications network.

The term “real-time image sensor” refers to a real-time sensor that captures image data objects representing a still representation of a particular environment. Similar to video sensors described herein, an image sensor may be fixed or mobile. It will be appreciated that a real-time video sensor and a real-time image sensor may include the same or similar hardware, for example one or more CMOS sensors specially configured by software to provide video and/or image capture functionality. The term “real-time image data” refers to high-fidelity image data transmittable continuously or near-continuously over a high-throughput communications network. Non-limiting examples of image data include still image data object(s), video data object(s), and individual frames of video data object(s).

The term “real-time motion sensor” refers to a real-time sensor that captures data representing motion within a particular environment. Non-limiting examples of a real-time motion sensor include an ultrasonic motion sensor, a radio frequency motion sensor, and an infrared motion sensor. The term “real-time motion data” refers to high-fidelity motion data transmittable continuously or near-continuously over a high-throughput communications network.

The term “individual model” refers to a machine learning, artificial intelligence, and/or data-driven model that is trained and/or maintained by a particular computing device embodying or as part of an AI robot. In some embodiments, an individual model is trained based on an environment perception data set aggregated by the AI robot maintaining the individual model. The term “updated individual model” refers to an individual model associated with a particular AI robot that is updated based at least in part on a new and/or updated environment perception data.

The term “real-time data central learning system” refers to one or more computing device(s) specifically configured via hardware, software, firmware, and/or a combination thereof, to continuously and/or in real-time or near-real-time, over at least one high-throughput communications network, receive data embodying or associated with individual model(s), and to generate and/or update a central model based at least in part on such data. In some embodiments, the real-time data central learning system includes one or more computing device(s) that receives data embodying and/or associated with an individual model from each of a plurality of AI robots, and generates a central model based on each of the received data embodying and/or associated with individual models. In some embodiments, the real-time data central learning system includes one or more computing device(s) that receive error data associated with each individual model from a plurality of AI robots, and generates a central model based at least in part on each of the received error data.

The term “central model” refers to a machine learning, algorithmic, artificial intelligence, and/or other data-driven model trained from data embodying or associated with a plurality of individual models, each individual model trained by a particular AI robot. The term “updated central model” refers to an existing central model updated based at least in part on new data associated with new individual model(s) and/or newly updated individual model(s).

The term “error data object” refers to electronically managed data representing erroneous results data generated by a particular model, and/or a failed operation attempted based on results data from one or more particular model(s). In some embodiments, an AI robot performs any one or more algorithm(s) embodying data-driven determinations that indicate when an attempted operation has failed. In some embodiments, an error data object includes a set or subset of sensor data that was processed by a particular model and resulted in a detected error, failed goal, and/or incomplete task.

The term “accuracy data” refers to electronically managed value(s) indicating a likelihood of erroneous result data being generated by a particular model. Non-limiting examples of accuracy data include one or more data values embodying an error rate for a particular model and/or a confidence interval associated with the particular model.

The term “preferred model” refers to a model selected for use from a plurality of model(s) based at least in part on maximization and/or minimization of one or more data value(s). In some embodiments, a preferred model is selected from two or more possible models based on a comparison between accuracy data for such possible models, such that the model associated with accuracy data representing a higher accuracy is selected.

### Example Systems and Apparatuses of the Disclosure

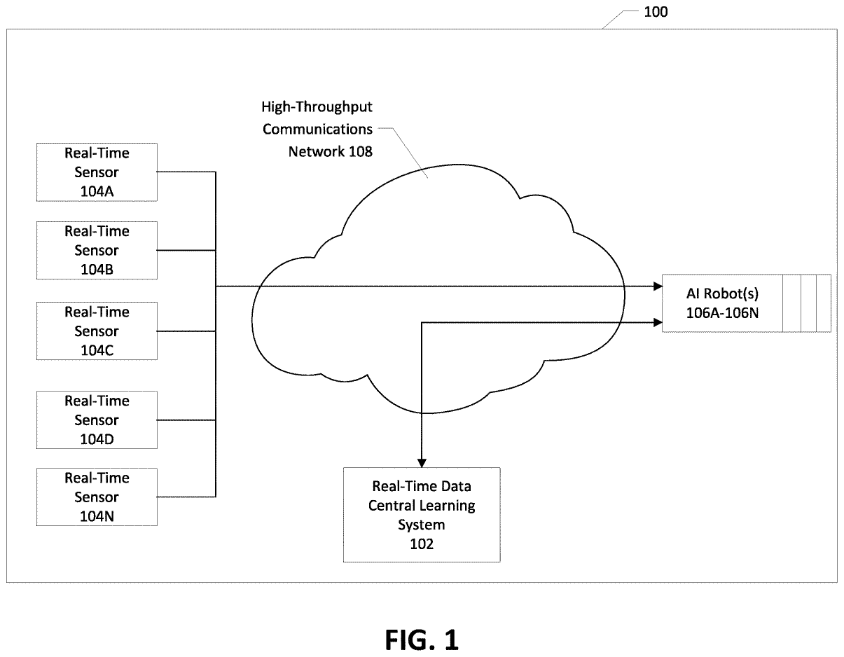

FIG. 1 illustrates a block diagram of a system that may be specially configured within which embodiments of the present disclosure may operate. Specifically, FIG. 1 depicts an example system 100 configured to enable continuous perception data learning for any number of AI robots within a particular environment or a plurality of environment(s). The system 100 includes one or more real-time sensor(s) 104A-104N (collectively “real-time sensors 104”), one or more AI robot(s) 106A-106N (collectively “AI robot(s) 106”), and a real-time data central learning system 102. The real-time data central learning system 102 is communicable with one or more other computing device(s), such as some or all of the AI robot(s) 106 and/or some or all of the real-time sensors 104, over the high-throughput communications network 108. In some embodiments, the real-time data central learning system 102 communicates with only the AI robot(s) 106 via the high-throughput communications network 108.

The plurality of real-time sensors 104 may include any number of real-time sensors that monitor one or more aspects of a particular environment, or a plurality of environments. Each of the real-time sensors 104 is configured to capture sensor data in real-time, and in real-time or near-real-time continuously transmit such real-time sensor data for processing. In some embodiments, for example, each of the real-time sensor(s) communicates captured real-time sensor data to one or more of the AI robot(s) 106 for use in generating and/or updating an individual model maintained by one or more of the AI robot(s) 106. In this regard, the real-time sensors 104 may provide various portions of real-time sensor data that may be utilized to determine a context, operations, characteristics, and/or other facets of an environment and/or interactions occurring within the environment (e.g., by the AI robot(s) 106).

The real-time sensors 104 may include a myriad of different sensor types that each one or more types of sensor data. For example, the real-time sensors 104 may include one or more real-time video sensors, image sensors, LiDAR sensors, motion sensors, range sensors, RFID sensors, and/or the like, or a combination thereof. It will be appreciated that each of these types of real-time sensors may capture a different sensor data type, for example a video sensor may capture real-time video data, an image sensor may capture real-time image data, a LiDAR sensor may capture real-time LiDAR data (e.g., high-fidelity point cloud data), and the like. In this regard, an environment perception data set may be generated and/or received by one or more computing device(s), such as one or more of the AI robot(s) 106, that includes various subsets of data from each particular real-time sensor of the real-time sensors 104 and/or various subsets of data of a particular sensor data type received from one or more real-time sensors of the real-time sensors 104. Additionally or alternatively, in some embodiments, the various types of real-time sensor data may provide additional context and/or enable different determination(s) to be performed based on various individual portions of data of a particular sensor data type and/or a combination of sensor data types.

In some embodiments, each real-time sensor of the real-time sensors 104 is configured for communication of captured real-time sensor data to one or more other computing devices, such as the AI robot(s) 106, via the high-throughput communications network 108. Each of the real-time sensors 104 may communicate the captured real-time sensor data in a continuous, real-time manner, such that the AI robot(s) (and/or other computing device(s), such as the real-time data central learning system 102) that receive the real-time sensor data such real-time sensor data continuously and/or in real-time or near-real-time for processing. In some embodiments, each real-time sensor of the real-time sensors 104 includes hardware, software, firmware, and/or a combination thereof, that enables continuous, real-time or near-real-time transmission of the captured real-time sensor data over the high-throughput communications network 108 (e.g., high-frequency signal producing chips, antennas, and/or the like). Alternatively or additionally, in some embodiments, one or more real-time sensor(s) of the real-time sensors 104 is directly communicable with a computing device embodied in hardware, software, firmware, and/or a combination thereof, that performs the real-time or near-real-time, continuous transmission of sensor data via the high-throughput communications network 108.

The AI robot(s) 106 each include any number of computing device(s) and/or system(s) that facilitate model-based interaction within an environment. In some embodiments, the AI robot(s) 106 include one or more computing device(s) embodied in hardware, software, firmware, and/or a combination thereof, that provide for aggregation of real-time sensor data into an environment perception data set, generation and/or maintenance of an individual model based at least in part on the environment perception data set, and/or interaction with an environment based at least in part on one or more individual model(s). Additionally or alternatively, in some embodiments, one or more of the AI robot(s) 106 includes specialized component(s) embodied in hardware, software, firmware, and/or a combination thereof, for interacting with the environment. For example, in some embodiments, an AI robot includes specialized arm(s), manipulator(s), actuator(s), and/or other mechanism(s) that enable interaction with an environment to perform a particular task operation (e.g., to lift an item, position an item, interact with an item, and/or the like). Additionally or alternatively, in some embodiments, an AI robot includes specialized wheel(s), roller(s), leg(s), and/or other mechanism(s) that enable movement and/or traversal throughout an environment. Non-limiting examples of AI robot(s) 106 include one or more autonomous vehicles, specially configured autonomous robots, adaptive autonomous vehicles (e.g., having multiple specialized components for performing multiple task operations), and/or the like.

In some embodiments, one or more of the AI robot(s) 106 includes hardware, software, firmware, and/or a combination thereof, that receive real-time sensor data embodying an environment perception data set. In this regard, the AI robot(s) 106 may utilize the high-throughput communications network 108 to receive real-time, continuous transmissions of sensor data from one or more of the real-time sensors 104. Alternatively or additionally, in some embodiments, one or more of the AI robot(s) 106 includes one or more on-board real-time sensors that capture sensor data and directly transmit such captured sensor data for processing (e.g., without use of the high-throughput communications network 108). The AI robot(s) 106 may store and/or process all received sensor data, for example regardless of whether such sensor data was received from one or more onboard real-time sensors and/or one or more external real-time sensors monitoring a particular environment. In some embodiments, one or more of the AI robot(s) 106 maintains a buffer embodying the environment perception data set comprising one or more portions of received real-time sensor data. Such a buffer of sensor data may be updated at occurrence of particular events and/or determinations, updated over time, or overwritten as new data is received that exceeds the buffer length by deleting older sensor data.

In some embodiments, one or more of the AI robot(s) 106 includes hardware, software, firmware, and/or a combination thereof, that generates and/or updates one or more model(s). A particular AI robot may maintain an individual model that generates results data utilized for performing one or more determination(s) and/or initiating one or more particular operations. In some embodiments, for example, one or more individual model(s) are trained and maintained that are subsequently utilized to initiate process(es) for interacting with the environment, such as to perform one or more task operation(s). In some embodiments, the AI robot(s) 106 maintain perception model(s) that generate results data utilized in navigating throughout an environment and/or performing one or more interactions for accomplishing a task operation. Such model(s) may be embodied by any of a myriad of model types, including a reinforcement learning model, a neural network, a regression model, and/or the like.

As described herein, the AI robot(s) 106 may receive a continuous, real-time set of sensor data from any of the real-time sensors 104, other real-time sensor(s) onboard the AI robot(s) 106, and/or the like. In some embodiments, the AI robot(s) 106 process such data to perform one or more operations to interact with the environment. Additionally, in some embodiments, the AI robot(s) 106 further learn from and/or otherwise maintain the model(s) based at least in part on the newly received real-time sensor data. In some embodiments, as new real-time sensor data is received from one or more of the real-time sensors 104, the AI robot(s) 106 process such newly received real-time sensor data to further train and update the one or more individual model(s) based at least in part on error data generated via the model(s) using the newly received real-time sensor data. Alternatively or additionally, in some embodiments, the AI robot(s) 106 update the one or more model(s) directly based at least in part on the real-time sensor data.

The real-time data central learning system 102 includes one or more computing device(s) embodied in hardware, software, firmware, and/or a combination thereof, that provides functionality for data model maintenance. Specifically, in some embodiments, the real-time data central learning system 102 provides functionality for generating and/or updating a central model utilizing federated learning mechanisms, such that the central model learns trends from any of a number of individual model(s) associated with independently learning computing devices. In this regard, the real-time data central learning system 102 may include one or more specially configured server(s), database(s), and/or other computing device(s), that aggregate data embodying and/or associated with individual model(s) maintained by each of the AI robot(s) 106, and utilizes at least such data to generate and/or update a central model. Additionally or alternatively, in some embodiments, the one or more specially configured server(s), database(s), and/or other computing device(s) distribute the generated and/or updated central model for use by one or more independent computing device(s), such as the AI robot(s) 106. It will be appreciated that the real-time data central learning system 102 may be embodied entirely by one or more back-end computing systems, or in some embodiments may include one or more peripheral device(s), display(s), and/or other computing hardware, firmware, and/or software that enables direct and/or indirect user input, review, and/or other interactions.

In some embodiments, the real-time data central learning system 102 aggregates data embodying and/or otherwise associated with individual model(s) for utilized for perception and/or interaction within an environment by each of the AI robot(s) 106. The real-time data central learning system 102 may gather such data automatically (e.g., in response to continuous transmission by each of the AI robot(s) 106, and/or at particular time intervals), in response to data received from one of the AI robot(s) 106 indicating the individual model maintained by the AI robot has been updated, or via request to each of the AI robot(s) 106 (e.g., automatically triggered upon certain data-driven determination(s), at particular timestamp interval(s), and/or upon user initiation of updating). In some embodiments, the real-time data central learning system 102 continuously aggregates, in real-time or near-real-time, individual models from the AI robot(s) 106 such that a central model may be generated and/or updated and subsequently distributed similarly continuously. In this regard, the real-time data central learning system 102 may leverage the high-throughput communications network 108 to enable such continuous, real-time transmission of high-fidelity (e.g., point cloud data, high-resolution color images such as RGB and/or RGBA images, proximity data, and/or the like) data in a manner that remains sufficiently low latency, high throughput, and high bandwidth. In some other embodiments, the real-time data central learning system 102 additionally or alternatively receives, from the AI robot(s) 106, error data, real-time environment sensor data, and/or other data that may be used to generate and/or update the central model alone or in conjunction with the individual models) received from such AI robot(s).

The high-throughput communications network 108 may embody any of a myriad of low latency, high-throughput, high-bandwidth, and/or otherwise high-transmission rate network configurations. In some embodiments, a high-throughput communications network 108 includes any number of networked computing devices embodying a 5G network. In another example context, a high-throughput communications network 108 includes one or more Wi-Fi 6-enabled network access points, relay(s), and/or the like. The high-throughput communications network 108 enables continuous and/or real-time communication between the real-time sensors and the AI robot(s) 106, and/or in some embodiments between the AI robot(s) 106 and the real-time data central learning system 102. Alternatively or additionally still, in some embodiments the high-throughput communications network 108 enables direct communication between the real-time sensors 104 and the real-time data central learning system 102. For example, in some embodiments, the high-throughput communications network 108 includes one or more base station(s), relay(s), router(s), relay(s), switch(es), cell tower(s), communication cable(s), routing station(s), and/or the like. The high-throughput communications network 108 may include a plurality of network access points and/or relay points that are proximate to one another to facilitate high-frequency transport of high fidelity transmissions over a shorter range than non-high-throughput communications networks.

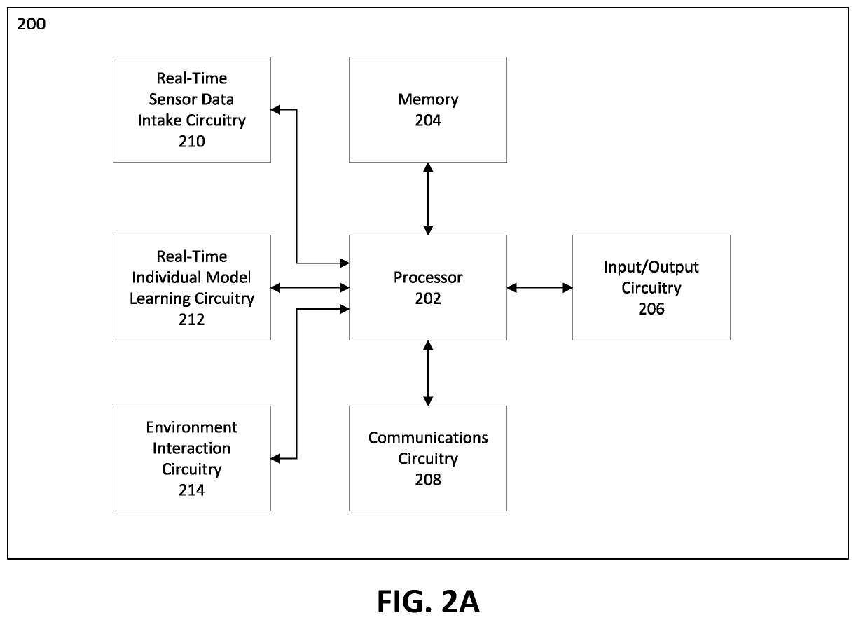

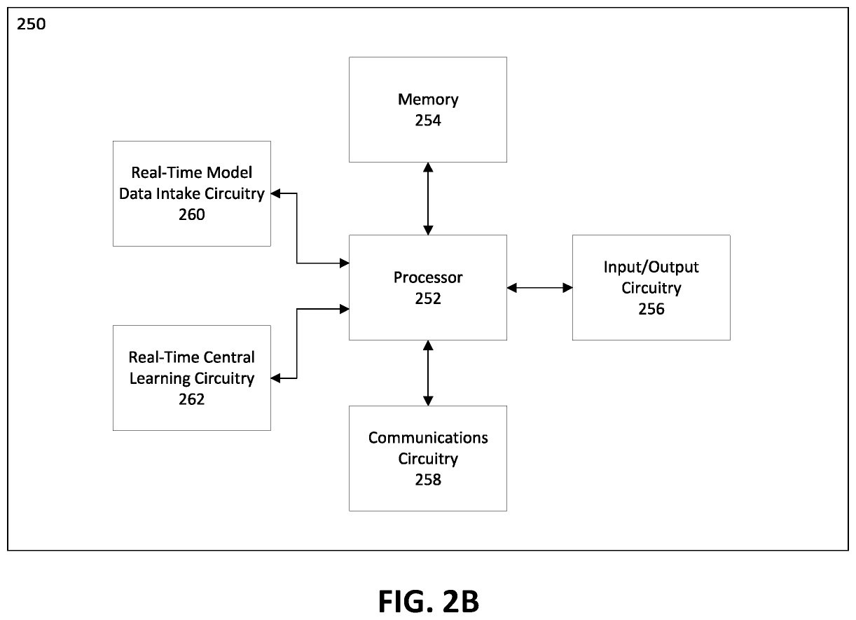

FIG. 2A illustrates a block diagram of an example AI robot apparatus that may be specially configured in accordance with an example embodiment of the present disclosure. In some embodiments, each or one or more of the AI robot(s) 106 is embodied by one or more computing device(s), such as the AI robot apparatus 200 as depicted and described in FIG. 2. The AI robot apparatus 200 includes a processor 202, a memory 204, input/output circuitry 206, communications circuitry 208, sensor data intake circuitry 210, real-time individual model learning circuitry 212, and environment interaction circuitry 214. The AI robot apparatus 200 may be configured, using one or more of the sets of circuitry 202, 204, 206, 208, 210, 212, 214, and/or 216, to execute the operations described herein.

Although components are described with respect to functional limitations, it should be understood that the particular implementations necessarily include the user of particular computing hardware. It should also be understood that certain of the components described herein may include similar or common hardware. For example, two sets of circuitry may both leverage use of the same processor(s), network interface(s), storage medium(s), and/or the like, to perform their associated functions, such that duplicate hardware is not required for each set of circuitry. The user of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively or additionally, in some embodiments, other elements of the AI robot apparatus 200 may provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) may be in communication with the memory 204 via a bus for passing information among components of the AI robot apparatus 200 In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the AI robot apparatus 200 to carry out various functions in accordance with example embodiments of the present disclosure.

The processor 202 may be embodied in a number of different ways. For example, in some example embodiments, the processor 202 includes one or more processing devices configured to perform independently. Additionally or alternatively, in some embodiments, the processor 202 includes one or more processor(s) configured in tandem via a bus to enable independent execution of instructions, pipelining, and/or multithreading. The use of the terms “processor” and “processing circuitry” may be understood to include a single core processor, a multi-core processor, multiple processors internal to the AI robot apparatus 200, and/or one or more remote or “cloud” processor(s) external to the AI robot apparatus 200.

In an example embodiment, the processor 202 may be configured to execute instructions stored in the memory 204 or otherwise accessible to the processor. Alternatively or additionally, the processor 202 in some embodiments is configured to execute hard-coded functionality. As such, whether configured by hardware or software methods, or by a combination thereof, the processor 202 may represent an entity (e.g., physically embodied in circuitry) capable of performing operations according to an embodiment of the present disclosure while configured accordingly. Alternatively or additionally, as another example in some example embodiments, when the processor 202 is embodied as an executor of software instructions, the instructions may specifically configure the processor 202 to perform the algorithms embodied in the specific operations described herein when such instructions are executed.

As one particular example, the processor 202 may be configured to perform various operations associated with real-time, continuous data aggregation and/or processing for utilizing in conjunction with one or more local model(s) to interact with the environment and maintaining the one or more local model(s), for example as described with respect to operation of any of the AI robot(s) 106 and/or as described further herein. In some embodiments, the processor 202 includes hardware, software, firmware, and/or a combination thereof, that receives a continuous flow of one or more portions of real-time sensor data from any number of real-time sensors associated with an environment, and aggregates such real-time sensor data to receive an environment perception data set. Additionally or alternatively, in some embodiments, the processor 202 includes hardware, software, firmware, and/or a combination thereof, that applies the real-time sensor data of the environment perception data set to one or more model(s) to generate results data and/or otherwise initiate one or more process(es) for interacting with the environment. Additionally or alternatively, in some embodiments, the processor 202 includes hardware, software, firmware, and/or a combination thereof, that controls movement of the AI robot apparatus 200, for example via one or more movable components of the AI robot apparatus 200. Additionally or alternatively, in some embodiments, the processor 202 includes hardware, software, firmware, and/or a combination thereof, that detects error data object(s) in response to operation of one or more of the individual model(s) and/or initiated process(es) for interacting with the environment. Additionally or alternatively, in some embodiments, the processor 202 includes hardware, software, firmware, and/or a combination thereof, that updates the individual model(s) based at least in part on the real-time sensor data of an environment perception data set, for example either directly using such data or utilizing data derived therefrom (e.g., error data object(s) resulting from use of such individual model(s)).

In some embodiments, the AI robot apparatus 200 includes input/output circuitry 206 that may, in turn, be in communication with processor 202 to provide output to the user and, in some embodiments, to receive an indication of a user input. The input/output circuitry 206 may comprise one or more user interface(s) and may include a display that may comprise the interface(s) rendered as a web user interface, an application user interface, a user device, a backend system, or the like. In some embodiments, the input/output circuitry 206 may also include a keyboard, a mouse, a joystick, a touch screen, touch areas, soft keys a microphone, a speaker, or other input/output mechanisms. The processor 202 and/or input/output circuitry 206 comprising the processor may be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 is optionally excluded, for example in embodiments where the AI robot apparatus 200 is entirely autonomous and no user input and/or output is desired.

The communications circuitry 208 may be any means such as a device or circuitry embodied in either hardware or a combination of hardware and software that is configured to receive and/or transmit data from/to a network and/or any other device, circuitry, or module in communication with the AI robot apparatus 200. In this regard, the communications circuitry 208 may include, for example, a network interface for enabling communications with a wired or wireless communication network. For example, the communications circuitry 208 may include one or more network interface card(s), antenna(s), bus(es), switch(es), router(s), modem(s), and supporting hardware, firmware, and/or software, or any other device suitable for enabling communications via one or more communication network(s). Additionally or alternatively, the communications circuitry 208 may include circuitry for interacting with the antenna(s) and/or other hardware or software to cause transmission of signals via the antenna(s) or to handle receipt of signals received via the antenna(s). In some embodiments, the communications circuitry 208 enables transmission of data (e.g., to a real-time data central learning system 102 and/or other computing device associated with the AI robot apparatus 200) and/or receipt of data (e.g., real-time, continuous sensor data from one or more real-time sensor(s), model(s) from a real-time data central learning system, and/or data from other AI robot(s)) in communication with the AI robot apparatus 200. In some embodiments, the communications circuitry 208 enables transmission of data and/or receiving of data via one or more high-throughput communications network(s).

The sensor data intake circuitry 210 includes hardware, software, firmware, and/or a combination thereof, that supports various functionality associated with real-time data aggregation. In some embodiments, the sensor data intake circuitry 210 includes hardware, software, firmware, and/or a combination thereof, that receives and/or requests real-time sensor data from one or more real-time sensor(s). In some embodiments, the sensor data intake circuitry 210 continuously receives and/or requests such real-time sensor data from the one or more real-time sensor(s), such that the available real-time sensor data available for processing is consistently updated. Additionally or alternatively, in some embodiments, the sensor data intake circuitry 210 includes hardware, software, firmware, and/or a combination thereof, that embodies one or more real-time sensor(s) onboard the AI robot apparatus 200, and/or hardware, software, firmware, and/or any combination thereof, that controls capture of real-time sensor data utilizing the one or more onboard real-time sensor(s). Additionally or alternatively, in some embodiments, the sensor data intake circuitry 210 includes hardware, software, firmware, and/or a combination thereof, that maintains a buffer of any number of portions of real-time sensor data from any number of real-time sensors, the buffer embodying an environment perception data set. Additionally or alternatively, in some embodiments, the sensor data intake circuitry 210 includes hardware, software, firmware, and/or a combination thereof, that otherwise receives an environment perception data set based at least in part on one or more portions of real-time sensor data received from one or more real-time sensor(s) associated with an environment. It will be appreciated that, in some embodiments, sensor data intake circuitry 210 may include a separate processor, specially configured field programmable gate array (FPGA), or a specially programmed application specific integrated circuit (ASIC).

The real-time individual model learning circuitry 212 includes hardware, software, firmware, and/or a combination thereof, that supports various functionality associated with utilizing and/or maintaining one or more individual model(s). For example, in some embodiments, the real-time individual model learning circuitry 212 maintains and/or utilizes specially configured AI model(s) that enable initiation of process(es) and/or other interaction with an environment. In some embodiments, the real-time individual model learning circuitry 212 includes hardware, software, firmware, and/or a combination thereof, that stores one or more specially configured individual model(s) for utilization. Additionally or alternatively, in some embodiments, the real-time individual model learning circuitry 212 includes hardware, software, firmware, and/or a combination thereof, that applies one or more portions of real-time sensor data from an environment perception data set to the one or more individual model(s). Additionally or alternatively, in some embodiments, the real-time individual model learning circuitry 212 includes hardware, software, firmware, and/or a combination thereof, that generates error data based at least in part on results data generated from use of one or more individual model(s).

Additionally or alternatively, in some embodiments, the real-time individual model learning circuitry 212 includes hardware, software, firmware, and/or a combination thereof, that updates one or more individual model(s) maintained by the AI robot apparatus 200 based at least in part on one or more portions of real-time sensor data. Additionally or alternatively, in some embodiments, the real-time individual model learning circuitry 212 includes hardware, software, firmware, and/or a combination thereof, that updates one or more individual model(s) maintained by the AI robot apparatus 200 based at least in part on data derived from the results of utilizing the one or more individual model(s), for example based on error data object(s) derived from results data produced by the one or more individual model(s). Additionally or alternatively, in some embodiments, the real-time individual model learning circuitry 212 includes hardware, software, firmware, and/or a combination thereof, that performs one or more determination(s) indicating a failed operation, and generates error data based at least in part on such determination(s). It will be appreciated that, in some embodiments, real-time individual model learning circuitry 212 may include a separate processor, specially configured field programmable gate array (FPGA), or a specially programmed application specific integrated circuit (ASIC).

The environment interaction circuitry 214 includes hardware, software, firmware, and/or a combination thereof, that supports various functionality associated with interacting with an environment associated with the AI robot apparatus 200. For example, in some embodiments, the AI robot apparatus 200 interacts with a particular environment to travel through said environment and perform one or more task operation(s) assigned to the AI robot apparatus 200. In some embodiments, the environment interaction circuitry 214 includes hardware, software, firmware, and/or a combination thereof, that receives and/or maintains data representing a task operation to be performed by the AI robot apparatus 200. The task operation may be received from one or more external computing devices (e.g., a task assignment system, another AI robot, and/or the like), may be determined based on a task process including any number of task operation(s) to be performed, and/or may be determined based on determination(s) associated with a status or other aspect of the environment. Additionally or alternatively, in some embodiments, the environment interaction circuitry 214 includes hardware, software, firmware, and/or a combination thereof, that enables movement of the AI robot apparatus 200 based on a determined target location, for example associated with a target location for a task operation to be performed and/or perception of the portion of the environment surrounding the AI robot apparatus 200. Additionally or alternatively, in some embodiments, the environment interaction circuitry 214 includes hardware, software, firmware, and/or a combination thereof, that controls one or more mechanism(s) that physically interact with the environment surrounding the AI robot apparatus 200. For example, the environment interaction circuitry 214 may include one or more robotic arm(s), conveyor(s), or other specialized mechanism(s) that interact with the environment and/or items in the environment to perform particular task(s), and/or relevant hardware, software, firmware, and/or a combination thereof, that controls the specialized mechanism(s). In some embodiments, for example, the environment interaction circuitry 214 includes hardware, software, firmware, and/or a combination thereof, that applies one or more portions of real-time sensor data to one or more individual model(s), and utilizes the results data produced by said individual model(s) to control the specialized mechanism(s) in a manner that progresses completion of a particular task operation. Additionally or alternatively still, in some embodiments, the environment interaction circuitry 214 includes hardware, software, firmware, and/or a combination thereof, that detects errors associated with results data generated via a particular model and/or errors associated with process(es) initiated based at least in part on results data generated via a particular model. In some such embodiments, the environment interaction circuitry 214 includes hardware, software, firmware, and/or a combination thereof, that generates error data object(s) representing or otherwise associated with detected error(s). It will be appreciated that, in some embodiments, environment interaction circuitry 214 may include a separate processor, specially configured field programmable gate array (FPGA), or a specially programmed application specific integrated circuit (ASIC).

Additionally or alternatively, in some embodiments, one or more of the sets of circuitries 202-214 are combinable. Alternatively or additionally, in some embodiments, one or more of the sets of circuitry perform some or all of the functionality described associated with another component. For example, in some embodiments, one or more of the sets of circuitry 202-214, such as two or more of the sensor data intake circuitry 210, the real-time individual model learning circuitry 212, and/or the environment interaction circuitry 214, are combined into a single module embodied in hardware, software, firmware, and/or a combination thereof. Similarly, in some embodiments, one or more of the sets of circuitry, for example the sensor data intake circuitry 210, real-time individual model learning circuitry 212, and/or the environment interaction circuitry 214 are combined such that the processor 202 performs one or more of the operations described above with respect to each of these modules.

FIG. 2B illustrates a block diagram of an example central learning apparatus that may be specially configured in accordance with an example embodiment of the present disclosure. In some embodiments, the real-time data central learning system 102 is embodied by one or more computing device(s), such as the central learning apparatus 250 as depicted and described in FIG. 2B. The central learning apparatus 250 includes a processor 252, a memory 254, input/output circuitry 256, communications circuitry 258, real-time model data intake circuitry 260, and/or real-time central learning circuitry 262. The central learning apparatus 250 may be configured using one or more of the sets of circuitry to execute the operations described herein. The sets of circuitry 252-262 may function similarly or identically to the similarly-named sets of circuitry depicted and described with respect to the AI robot apparatus 200. For purposes of brevity, repeated disclosure with regard to the functionality of such similarly-named sets of circuitry is omitted herein.

The real-time model data intake circuitry 260 includes hardware, software, firmware, and/or a combination thereof, that supports various functionality associated with aggregating data embodying and/or associated with individual model(s) of one or more associated AI robot(s). For example, in some embodiments, the real-time model data intake circuitry 260 includes hardware, software, firmware, and/or a combination thereof, that receives an individual model set including various data embodying individual models trained by each of a plurality of AI robots communicable with the central learning apparatus 250. Alternatively or additionally, in some embodiments, the real-time model data intake circuitry 260 includes hardware, software, firmware, and/or a combination thereof, that receives a data set comprising other data associated with individual model(s) that is used for training. For example, in some embodiments the real-time model data intake circuitry 260 receives and/or requests, from each of one or more AI robot(s), error data object(s) associated with one or more individual model(s) maintained by such AI robot(s). In some embodiments, the real-time model data intake circuitry 260 receives a continuous, real-time flow of data embodying the individual model(s) from such AI robot(s) as the individual model(s) are generated and/or updated. It will be appreciated that, in some embodiments, the real-time model data intake circuitry 260 may include a separate processor, specially configured field programmable gate array (FPGA), or a specially programmed application specific integrated circuit (ASIC).

The real-time central learning circuitry 262 includes hardware, software, firmware, and/or a combination thereof, that supports various functionality associated with central model training and/or distribution. In some embodiments, the real-time central learning circuitry 262 includes hardware, software, firmware, and/or a combination thereof, that trains a central model from one or more individual model(s), the individual model(s) associated with and/or received from AI robot(s) communicable with the central learning apparatus 250. The real-time central learning circuitry 262 may store the central model for subsequent retrieval. Additionally or alternatively, in some embodiments, the real-time central learning circuitry 262 includes hardware, software, firmware, and/or a combination thereof, that updates a central model based at least in part on newly received data embodying or associated with new and/or updated individual model(s). In some embodiments, the real-time central learning circuitry 262 includes hardware, software, firmware, and/or a combination thereof, that performs further training of a stored central model based at least in part on newly received data, and/or that generates a new, updated central model based at least in part on the newly received data. Additionally or alternatively, in some embodiments, the real-time central learning circuitry 262 includes hardware, software, firmware, and/or a combination thereof, that distributes a newly generated, previously stored, and/or updated central model to one or more external computing devices. For example, in some embodiments, the real-time central learning circuitry 262 includes hardware, software, firmware, and/or a combination thereof, to provide a central model to one or more AI robot(s) in real-time or near-real-time upon generation and/or updating of the central model. In this regard, the central learning apparatus 250 may facilitate a continuous, real-time or near-real-time loop communication loop for receiving data associated with individual model(s) from any number of AI robot(s), generating or updating a central model based at least in part on the newly received data associated with the individual model(s), and distributing the central model to the AI robot(s) (and/or other AI robot(s)) for use. It will be appreciated that, in some embodiments, real-time central learning circuitry 262 may include a separate processor, specially configured field programmable gate array (FPGA), or a specially programmed application specific integrated circuit (ASIC).

Additionally or alternatively, in some embodiments, one or more of the sets of circuitries 252-262 are combinable. Alternatively or additionally, in some embodiments, one or more of the sets of circuitry perform some or all of the functionality described associated with another component. For example, in some embodiments, one or more of the sets of circuitry 252-262, such as the real-time model data intake circuitry 260 and the real-time central learning circuitry 262 are combined into a single module embodied in hardware, software, firmware, and/or a combination thereof. Similarly, in some embodiments, one or more of the sets of circuitry, for example the real-time model data intake circuitry 260 and/or the real-time central learning circuitry 262, are combined such that the processor 252 performs one or more of the operations described above with respect to each of these modules.

### Example Environments of the Disclosure

Having described example systems, apparatuses, and data flows in accordance with the present disclosure, example visualizations of environments within which embodiments of the present disclosure may operate will now be discussed. The depicted environments may include or be associated with any number and/or types of real-time sensors, entities operating within the environment, item configurations within the environment, layouts, and/or the like. It will further be appreciated that the environments within which embodiments of the present disclosure operate may include or be associated with any number and/or types of computing devices, for example additional and/or alternative to the AI robots as depicted and described. In this regard, the specific environment visualizations as depicted and described herein are for illustrative purposes, and should not limit the scope and/or spirit of this disclosure.

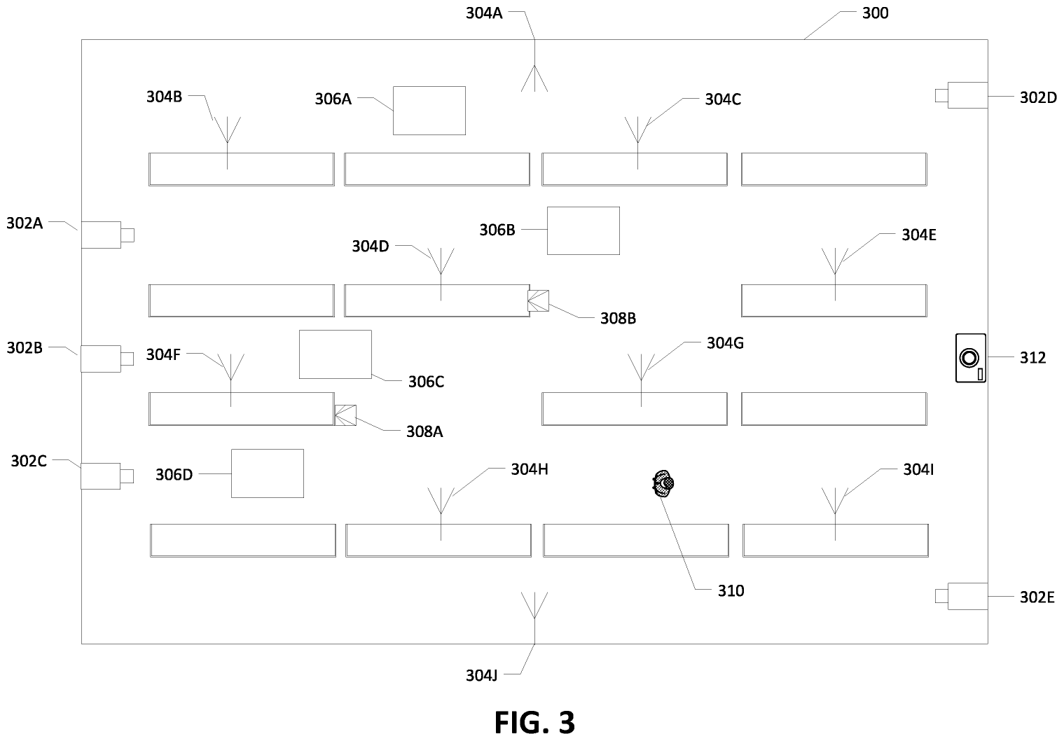

FIG. 3 illustrates an example visualization of a warehouse context for data collection and model training in accordance with at least some example embodiments of the present disclosure. Specifically, FIG. 3 depicts a visualization of an example environment 300 within which a plurality of AI robots operate. In one example context, the environment 300 embodies a warehouse environment within which one or more AI robot(s) operate to interact with the environment and facilitate performance of particular task operation(s) (e.g., item picking, identification, selection, repositioning, and/or removal from the environment 300). It will be appreciated that embodiments described herein may provide advantages within any of a myriad of environments. Accordingly, the specific environments depicted and described are for purposes of illustration and should not limit the scope or spirit of this disclosure.

The environment 300 may include any of a myriad of objects, including items, environmental elements, furniture, and/or the like. For example, the environment 300 may include one or more objects located throughout the environment at a fixed position, or that are otherwise not intended to be moved. Non-limiting examples of such objects include environment boundaries (e.g., walls, ceilings, floors, and/or the like that define the environment 300), furniture pieces, warehouse shelving units, conveyor belts, fixed machinery, and/or the like. Alternatively or additionally, in some embodiments, the environment 300 may include one or more items at one or more locations throughout. The items may embody products, goods, and/or other objects with which an AI robot or other entity within the environment 300 (e.g., a human picker) may interact, for example to perform one or more task operation(s). In one example context, the AI robots operate within the environment 300 to pick item(s) in the environment 300 for extraction, pick item(s) in the environment 300 for movement to a different location within the environment 300 or another environment, pick item(s) for packaging and shipping from the environment 300 to another location, and/or the like. In this regard, it will be appreciated that the environment 300 may include any number of such object(s), item(s), and/or other components to facilitate performance of such tasks.

The environment 300 includes a plurality of networking devices 304A-304J (collectively “networking devices 304”). The networking devices 304 embody at least a portion of a high-throughput communications network that is accessible to communicate data between any of the myriad of computing devices in or associated with the environment 300. For example, in some embodiments, the high-throughput communications network embodied by the plurality of networking devices 304 facilitates real-time and/or continuous transmission of sensor data from each of a myriad of real-time sensors within the environment 300 to one or more AI robot(s) within the environment 300. Additionally or alternatively, in some embodiments, the high-throughput communications network embodied by the plurality of networking devices 304 facilitates real-time and/or continuous transmission from one or more AI robot(s) to one or more external device(s) and/or system(s) (not depicted) associated with the environment 300, for example a real-time data central learning system 102 embodied by the central learning apparatus 250 as described herein. In some embodiments, the real-time data central learning system 102 embodied by the central learning apparatus 250 is located within the environment 300, proximate to the environment 300 (e.g., in a separate room, building, and/or other location within a particular threshold distance from the environment 300), and/or in a remote, non-proximate location facilitated by one or more additional networking device(s), for example embodying a high-throughput communications network. In some example contexts, the plurality of networking devices 304 facilitates continuous, real-time or near-real-time transmission of a sensor data to one or more AI robot(s) and/or a real-time data central learning system, and/or facilitates continuous, real-time or near-real-time transmission of data associated with or embodying a model from one or more AI robot(s) to a real-time data central learning system, where the AI robot(s) and/or real-time data central learning system is on-premises with respect to the environment 300. In other example contexts, the networking devices 304 facilitate such transmission to one or more AI robot(s) at a different location, and/or a real-time data central learning system embodied as a cloud-based system providing such functionality as depicted and described.

Each of the networking devices 304 may be affixed in any of a myriad of manners within the environment 300. For example, in some embodiments, one or more of the plurality of networking devices 304 may be affixed, either temporarily or permanently, to static or generally non-moving portions of the environment 300 (e.g., a wall, a ceiling, large tiered shelving objects, machinery, and/or the like). Additionally or alternatively, in some embodiments, one or more of the plurality of networking devices 304 may be affixed, either temporarily or permanently, to moving objects within the environment 300 (e.g., a moving AI robot, a portion of an AI robot, another autonomous vehicle, a manually-controlled vehicle, a moving element of a piece of machinery, and/or the like). The environment 300 may include any amount of networking devices arranged within the environment 300 to sufficiently provide high-throughput communication network services at all desired locations within the environment 300. The networking devices 304 may function in tandem to provide data transmission, relaying, and/or other communication throughout the environment 300.

The environment 300 further includes a plurality of AI robot(s) 306A-306D (collectively “AI robots 306”). The AI robots 306 may operate within the environment 300 to perform any of a myriad of action(s), interact within the environment 300, and/or otherwise perform one or more task operation(s). In some embodiments, for example, one or more of the AI robot(s) traverses throughout the environment 300 to interact with one or more item(s) within the environment 300 as part of performing a task operation assigned to the AI robot. Additionally or alternatively, in some embodiments, one or more of the AI robots 306 traverse throughout the environment 300 to perform any of a myriad of independent action(s), for example to traverse through the environment 300 to another environment, inspect the environment 300 for issues within the environment 300, and/or the like.

In some embodiments, each of the AI robots 306 operates based at least in part on one or more specially configured model(s) maintained by the AI robot of the AI robots 306. For example, in some embodiments, one or more of the AI robots 306 maintains an individual model embodying an artificial intelligence model that generates results data utilized to initiate process(es) for interacting with the environment of the AI robot. Alternatively or additionally, in some embodiments the individual model embodies an artificial intelligence model that initiates such process(es) for interacting with the environment 300 directly. In one example context, the artificial intelligence model may be specially configured to initiate operation(s) that perform and/or otherwise attempt performance of interaction(s) for completing one or more task operation(s) assigned to the AI robot. For example, the artificial intelligence model may produce results data that represents or informs generated instructions for moving one or more specialized components of the AI robot to interact with the environment 300 in a particular manner, for example to move a mechanical arm, grabber, movement mechanisms, and/or the like to identify and pick a particular item from within the environment 300. It will be appreciated that the artificial intelligence model may be implemented utilizing any of a myriad of artificial intelligence model implementations. In some embodiments, the artificial intelligence model embodies a reinforcement learning model that is specially configured to learn based on a particular defined goal metric or representation corresponding to a successfully completed task operation and/or portion thereof. Non-limiting examples of such reinforcement learning model implementations include safe reinforcement learning models, association reinforcement learning models, deep reinforcement learning models, inverse reinforcement learning models, and/or the like.

It will be appreciated that, in some such embodiments, an AI robot uses an individual model while simultaneously training said individual model based on such use. For example, one or more portions of sensor data (e.g., embodying an environment perception data set) may be processed by an individual model to interact with the environment 300 so as to progress or perform a particular task operation. In some embodiments, in circumstances where interactions and/or operations are performed without error the AI robot may update the individual model to “reward” such a positive interaction (e.g., by updating to increase the likelihood such an interaction is repeated). Alternatively or additionally, in some embodiments, in circumstances where interactions and/or operations are performed and an error is detected the AI robot may update the individual model to “punish” such a negative interaction (e.g., by updating to decrease the likelihood the error is repeated). In some embodiments, an AI robot may cease learning for a period of time (e.g., while being set to a particular mode purely for operation), or may cease learning once particular criteria is satisfied (e.g., an accuracy threshold is reached). In yet other embodiments, one or more of the AI robots continuously trains individual model(s) as it operates, thus continuously improving the likelihood that the AI robot successfully interacts with the environment without errors as the individual model is improved.

An environment may include any number of AI robots, each of which may be the same type of AI robot and/or a different type of AI robot. In this regard, each AI robot of the AI robots 306 may include any number of specialized component(s), mechanism(s), computing device(s), sensor(s), and/or the like, that enable the AI robot to perform one or multiple action(s) related to accomplishing any number of task operations. For example, in some embodiments, one or more of the AI robots 306 includes any number of onboard real-time sensors that provide sensor data utilized for perception, processing via one or more model(s), and/or the like. Additionally or alternatively, the one or more of the AI robots 306 includes hardware, software, firmware, and/or the like for communicating in real-time and/or continuously with other real-time sensors external to the AI robot, for example via a high-throughput communications network. In some embodiments, additionally or alternatively still, one or more of the AI robots 306 includes specialized mechanism(s) that enable interaction with the environment 300. For example, one or more of the AI robots 306 may include a robotic arm, an instruction-controlled forklift, a conveyor, and/or the like. Such specialized mechanism(s) may be controlled by sub-devices and/or circuitry of the AI robot, for example embodied in hardware, software, firmware, and/or any combination thereof. In some embodiments, another type of AI robot includes an autonomously-controlled vehicle, or semi-autonomous vehicle, that enables transportation of a user. Some such AI robots may additionally or alternatively output instructions, user interfaces, and/or other data associated with action(s) to be performed by the user, for example to progress or complete a particular task operation.

It will be appreciated that in some contexts, an environment may include only a single type of entity. For example, the environment 300 may include AI robots 306 each embodying entirely autonomous AI robots. Alternatively, in some contexts, the environment 300 may include a plurality of AI robot types. For example, the environment 300 may include AI robots 306 embodying one or more fully autonomous AI robots, one or more semi-autonomous AI robots, and separately include one or more human actor(s) (for example, the human actor 310) and/or manually-controlled vehicles, machinery, and/or the like. In some such contexts, the semi-autonomous AI robots and/or human actors may receive data-driven instructions, user interfaces, and/or other information generated based at least in part by one or more specialized models trained as described herein for progressing and/or completing a particular task operation.

The environment 300 further includes human actor 310. The human actor 310 may interact with the environment 300 and/or the AI robots 306 in any of a myriad of manners. For example, in some embodiments, the human actor 310 provides a dynamic environmental element that AI robots 306 are required to account for—such as by avoiding collisions with such human actors such as the human actor 310, avoiding interfering with the human actor 310, and/or the like. Additionally or alternatively, the AI robots 306 may interact with one or more human actors, such as the human actor 310, to perform one or more action(s) that progress and/or complete one or more task operation(s). Alternatively or additionally still, in some embodiments, the human actor 310 interacts with the environment 300 independently based on instructions, user interface(s), and/or other data provided to the human actor 310 via an associated client device and/or other computing device. In some such embodiments, the human actor 310 receives instructions, data, and/or user interfaces indicating interaction(s) to be performed by the human actor generated based at least in part on use of one or more model(s) specially configured in the manner described herein.

The environment 300 further includes a plurality of real-time sensors. Such a plurality of real-time sensors includes the real-time video sensors 302A-302E, the real-time motion sensors 308A-308B, and real-time image sensor 312. It will be appreciated that any of a myriad of other real-time sensors and/or sensor types may be located throughout the environment 300, for example one or more LiDAR sensors, range sensors, proximity-based data sensors (e.g., RFID sensors, Bluetooth beacons, and/or the like). Additionally or alternatively, the environment 300 may include one or more other real-time sensors onboard and/or associated with one or more of the AI robots 306, for example onboard video/image sensors, onboard LiDAR sensors, onboard location sensors, onboard range sensors, and/or the like embodied by a sub-component of any of the AI robots 306. All real-time sensors within the environment 300—whether onboard or external to one or more AI robots such as the AI robots 306—are collectively referred to as “the Real-Time Sensors.”

The Real-Time Sensors of the environment 300 provide real-time sensor data that may be processed for any of a myriad of purposes. In some embodiments, the real-time sensor data may be processed for monitoring and/or determining a status of the environment 300, scenarios occurring in the environment 300, a perception of the environment 300, and/or the like. In one example context, the real-time sensor data is transmitted from the Real-Time Sensors of the environment 300 to one or more of the AI robots 306 for use in processing via one or more model(s) maintained by the AI robots 306. For example, the AI robots 306 may process the real-time sensor data received from the Real-Time Sensors via one or more specially configured model(s) that perform perception of the environment 300 and/or a particular portion thereof (e.g., the area around the particular AI robot processing the data), initiate one or more process(es) for interacting with the environment 300, and/or the like.

It will be appreciated, as depicted and described herein, that the Real-Time Sensors include any of a myriad of sensor types, each sensor type capable of capturing a different type of sensor data. Non-limiting examples of such sensor types include real-time image sensors, real-time video sensors, real-time motion sensors, real-time range sensors, real-time LiDAR sensors, real-time location sensors, real-time RFID sensors, and/or the like. Each of these sensors may capture image data (e.g., still images, video frames, and/or the like), video data, motion data, range data, LiDAR data, location data, RFID data, and/or the like from within or otherwise associated with the environment 300. The various types of real-time sensor data provide context to aspects of the operations within the environment 300. Each of the Real-Time Sensors may transmit real-time sensor data to one or more computing devices (e.g., AI robots, or in some contexts a real-time data central learning system) continuously, such that these computing devices receive a continuous set of sensor data that includes the sensor data from each of the Real-Time Sensor over time for further processing. In this regard, based at least in part on the continuously updated real-time sensor data, the AI robots or other computing devices may perform real-time, up-to-date determinations and/or process(es) based on such data. For example, one or more AI robots may receive one or more continuous streams of real-time sensor data embodying an environment perception data set, and process such real-time sensor data via one or more specially configured individual models to perform one or more determination(s) regarding the status, events, and/or aspects of the environment 300, generate results data utilizing such individual model(s) based at least in part on such real-time sensor data, and/or initiate process(es) for interacting with the environment 300 based at least in part on the real-time sensor data, or the like.

The plurality of real-time sensors may be positioned at various locations throughout the environment 300, including without limitation affixed either permanently or temporarily to static and/or non-moving objects in the environment 300, affixed to one or more of the AI robots 306 in the environment 300, embodied onboard one or more of the AI robots 306 in the environment 300, and/or the like. For example, as illustrated, the environment 300 includes a plurality of fixed real-time video sensors 302A, 302B, and 302C affixed along the left wall in the depicted visualization of the environment 300, a plurality of fixed real-time video sensors 302D and 302E together with a fixed real-time image sensor 312 affixed along the right wall in the depicted visualization. Additionally, the environment 300 includes a plurality of fixed real-time motion sensors 308A and 308B affixed on large objects positioned in the environment 300, for example on side portions of large warehouse shelving units at locations where gaps in such shelving units are present. These fixed real-time sensors may remain in a known location and capture particular real-time sensor data representing a particular aspect of the environment 300 within a particular area monitored by the respective real-time sensor(s). In some embodiments, one or more of the fixed real-time sensors may pan, tilt, zoom, and/or otherwise rotate orientation and/or adjust the area(s) within the environment 300 monitored by the real-time sensor(s) without altering the location at which the real-time sensor is positioned. It will be appreciated that, in this regard, all of the Real-Time Sensors or a subset thereof that alone or in combination provide real-time sensor data embodying at least a portion of an environment perception data set processable by AI robots 306 and/or a real-time data central learning system using one or more specially configured model(s), such as to generate results data, initiate process(es) for interacting within the environment 300, and/or the like.

### Example Data Flows of the Disclosure

Having described example systems and apparatuses in accordance with the present disclosure, example visualizations of the data flows between such systems, devices, and/or apparatuses of the present disclosure will now be discussed. The depicted data flow(s) represent specific example data flows for aggregating and processing real-time sensor data transmitted over a high-throughput communications network (e.g., a continuous set of sensor data) and associated with a particular environment. It will be appreciated that, in other embodiments, such data flows may differ without deviating from the scope and spirit of this disclosure. For example, in some embodiments, other types of sensor data may be received and/or processed. Additionally or alternatively, in some embodiments, the generated output data types may differ based on the same and/or different input data. In this regard, the specific data flow(s) depicted herein should not limit the scope or spirit of this disclosure.

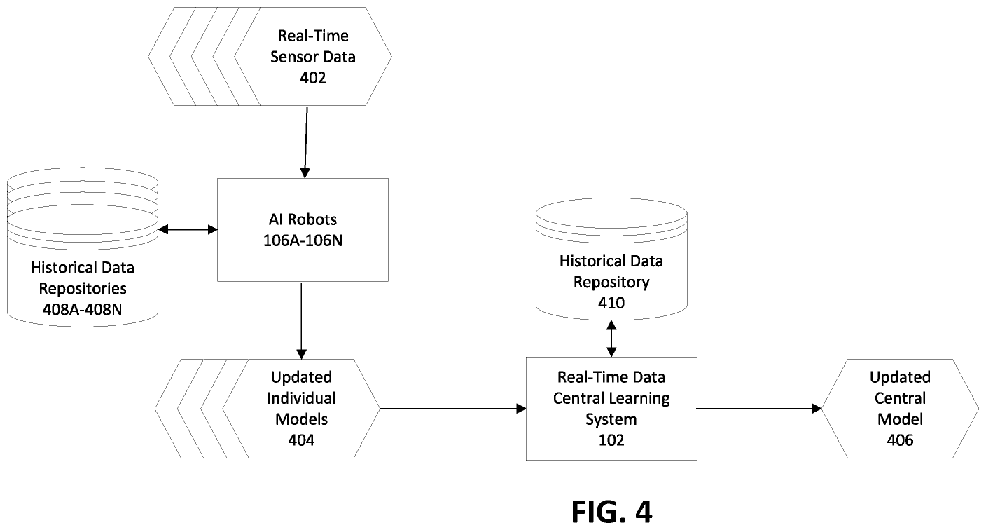

FIG. 4 illustrates example representations of data flow for model updating in accordance with at least some example embodiments of the present disclosure. Specifically, FIG. 4 illustrates aggregation and processing of real-time sensor data by AI robots 106A-106N to generate and/or update individual models, and subsequent aggregation and processing of such individual models by a real-time data central learning system 102. In some such embodiments, each of the AI robots 106A-106N is embodied by one or more specially configured computing devices, such as the AI robot apparatus 200. Additionally or alternatively, in some embodiments, the real-time data central learning system 102 is embodied by one or more specially configured computing devices, such as the central learning apparatus 250. Each of the AI robot(s) 106A-106N may include or otherwise communicate with a historical data repository of the historical data repositories 408A-408N. In some embodiments, each of the historical data repositories 408A-408N is embodied by one or more computing devices embodied in hardware, software, firmware, and/or a combination thereof, separate from a respective order of the AI robots 106A-106N. Additionally or alternatively, in some embodiments, each of the historical data repositories 408A-408N is embodied by hardware, software, firmware, and/or a combination thereof, within and/or otherwise controlled by a respective AI robot of the AI robots 106A-106N. In some embodiments, the historical data repository 410 is embodied by hardware, software, firmware, and/or a combination thereof, separate from the real-time data central learning system 102. Alternatively or additionally, in some embodiments, the historical data repository 410 is embodied by hardware, software, firmware, and/or a combination thereof, within and/or otherwise controlled by the real-time data central learning system 102. In some embodiments, for example, one or more of the historical data repositories 408A-408N and/or the historical data repository 410 is embodied virtually (e.g., as a virtual database maintained by one or more computing device(s) performing additional and/or alternative functionality) and/or otherwise in the cloud such that the respective computing devices and/or systems accessing the data repositories can do so without having access to the physical hardware upon which such historical data repository/historical data repositories is/are maintained.

As illustrated, the AI robots 106A-106N each receive one or more portions of real-time sensor data 104. The one or more portions of real-time sensor data 104 may embody an environment perception data set for processing by a respective AI robot of the AI robots 106A-106N. It will be appreciated that in some embodiments and contexts, one or more AI robots of the AI robots 106A-106N each receive an environment perception data set including the same portions of real-time sensor data 104. Alternatively or additionally, in some embodiments, one or more AI robots of the AI robots 106A-106N may each receive an environment perception data set including one or more different portions of the real-time sensor data 402, and/or one or more AI robots of the AI robots 106A-106N may each receive an environment perception data set including entirely different portions of the real-time sensor data 104. For example, in some embodiments, the AI robot 106A receives real-time sensor data from real-time sensors onboard the AI robot 106A and/or proximate to a location of the AI robot 106A, and AI robot 106B receives real-time sensor data from real-time sensors onboard the AI robot 106B and/or proximate to a second location of the AI robot 106B. In this regard, the portions of the real-time sensor data 402 embodying an environment perception data set received by each of the AI robots 106A-106N may be associated with the particular AI robot and/or particular to a relevant portion of the environment to be processed by the particular AI robot.

As described herein, the real-time sensor data 402 may include any number of different portions and/or different sensor data types. For example, in some embodiments, the real-time sensor data 402 includes real-time image data, real-time video data, real-time location data, real-time motion data, real-time LiDAR data, and/or the like. Real-time sensors in communication with the AI robots 106A-106N may capture and continuously communicate, in real-time or near-real-time and via a high-throughput communications network the sensor data to the one or more AI robots 106A-106N. In this regard, the real-time sensors may transmit such data as the sensor data is captured. The high-throughput communications network ma enable such transmission of high-fidelity data (e.g., large size, including several hundred megabytes or several gigabytes of data, such as high resolution and/or high number of frame image data) while maintaining the continuous, real-time or near-real-time nature of such communications.

The AI robots 106A-106N may each maintain one or more model(s). For example, in some embodiments, each of the AI robots 106A-106N maintains one or more model(s) utilized for initiating operations for interacting with an environment associated with each of the AI robots 106A-106N. In one example context, the AI robots 106A-106N initiate operations for interacting with an environment to perform task operation(s) within the environment. A particular AI robot of the AI robots 106A-106N may perform a task operation alone or in conjunction with one or more other AI robots of the AI robots 106A-106N. For example, in some embodiments, the AI robots 106A-106N embody a fleet of AI robots within a particular environment, such as a warehouse environment, that operate alone and/or in conjunction with one another to perform particular task operations within the environment (e.g., item picking and/or manipulation) based at least in part on the model(s) maintained by each of the AI robots 106A-106N. In some embodiments, the model(s) embody AI models specially configured to produce results date hat operates one or more mechanisms of an AI robot in a particular manner to attempt a particular task operation.

In some embodiments, each of the AI robots 106A-106N maintains an individual model that is preferred for use in initiating process(es) for performing task operation(s). In this regard, individual model maintained by the AI robot may embody a preferred model for use by the particular AI robot. As each AI robot of the AI robots 106A-106N operates, the AI robots may separate update the individual model maintained by each of said AI robots 106A-106N. In this regard, the AI robot 106A may maintain a first individual model, such that the first individual model is trained to generate a first updated individual model based on the particular operation of the AI robot 106A. In one particular example context, the AI robot 106A updates its stored individual model based at least in part on error data object(s) representing errors detected and/or otherwise generated from operations performed by the AI robot 106A based at least in part on data produced by the AI robot 106A's corresponding individual model. In this regard, the AI robot 106A independently updates the individual model maintained by said AI robot 106A to improve such erroneous operations based on the particular operation of the AI robot 106A. Similarly, the AI robot 106B may maintain a second individual model, such that the second individual model is trained to generate a second updated individual model based on the particular operation of the Ai robot 106B. In this regard, the AI robot 106B similarly independently updates the individual model maintained by said AI robot 106B to improve such erroneous operations based on the particular operation of the AI robot 106B. It will be appreciated that, as such AI robots 106A and 106B may perform different operations, the AI robots 106A and 106B may learn to improve different interaction(s), learn different methods of operation to reduce errors, and/or the like. Similarly, the individual models maintained by such AI robots 106A and 106B may diverge as each is updated independently.

In some embodiments, each of the AI robots 106A-106N maintains a historical data repository represented by the historical data repositories 408A-408N. For example, the AI robot 106A may maintain a first historical data repository 408A, the AI robot 106B may maintain a second historical data repository 408B, and so on. Each of the historical data repositories 408A-408N may include data received, generated, captured, and/or otherwise maintained by one of the AI robots 106A-106N for use in updating an individual model and/or operating the AI robot. For example, in some embodiments, each historical data repository 408A-408N stores the individual model for use by the corresponding AI robot of the AI robots 106A-106N, accuracy data associated with the individual model of the corresponding AI robot of the AI robots 106A-106N, some or all of previously received environment perception data set(s), and/or the like. In some embodiments, the historical data repositories 408A-408N are optional, such that the AI robots 106A-106N may not permanently maintain any such data repositories.

In some embodiments, each historical data repository of the historical data repositories 408A-408N maintains data previously generated, collected, and/or received by the corresponding AI robot of the AI robots 106A-106N that may be utilized to retrain one or more individual model(s) maintained and/or utilized by the corresponding AI robot. For example, in some embodiments, the historical data repository 408A may include sensor data previously collected by the AI robot 106A, previous versions of an individual model maintained by the AI robot 106A, error data object(s) previously generated by the AI robot 106A, and/or the like. Similarly, the historical data repository 408B may include sensor data previously collected by the AI robot 106B, previous versions of an individual model maintained by the AI robot 106B, error data object(s) previously generated by the AI robot 106B, and/or the like. In this regard, the each of the AI robots 106 may retrieve and/or utilize such data to process such stored data, re-train one or more individual model(s) from a historical point, and/or the like. For example, the historical data stored to one or more of the historical data repositories 408A-408N may be retrieved by a corresponding AI robot of the AI robots 106 to retrain an individual model on a particular type or subset of data, for a particular task, and/or the like. Alternatively or additionally, in some embodiments where the real-time training described herein results in a model with decreased accuracy, or ultimately yields an individual model that does not meet a minimum accuracy threshold, the historical data may be used to re-train a new individual model in another manner in an attempt to generate a more accurate individual model.

As the AI robots 106A-106N operate, the AI robots 106A-106N generate the updated individual models 404. The updated individual models 404 may include any number of updated individual models, each associated with a particular corresponding AI robot of the AI robots 106AA-106N. In some embodiments, the AI robots 106A-106N transmit the updated individual models 404 to a real-time data central learning system 102 for further processing. In some embodiments, the AI robots 106A-106N transmit the updated individual models 404 to the real-time data central learning system 102 via one or more high-throughput communication networks. In this regard, each AI robot of the AI robots 106A-106N may access a high-throughput communications network to transmit its associated updated individual model of the updated individual models 404 in real-time or near-real time as such an updated individual model is generated by the associated AI robot of the AI robots 106A-106N. It will be appreciated that, via one or more high-throughput communications networks, the real-time data central learning system 102 may continuous and in real-time and/or near-real-time receive any number of updated individual models from one or more of the AI robots 106A-106N, for example represented by the updated individual models 404. Alternatively or additionally, in some embodiments, the real-time data central learning system 102 requests the updated individual models 404 from the AI robots 106A-106N automatically, in response to particular determinations, at particular occurrences, and/or the like. For example, in some embodiments, the real-time data central learning system 102 requests updated individual models from each of the AI robots 106A-106N, and receives the updated individual models 404 in real-time or near-real-time in response, upon completion of a previous operation (e.g., a previous round of updating a central model as described herein). In other embodiments, each of the updated individual models 404 is transmitted together with additional data associated with such individual model(s), for example error data object(s), at least a portion of an environment perception data set, and/or the like.

The real-time data central learning system 102 may generate and/or maintain a central model. The central model may be generated from training data, generated from an initial federated learning process based at least in part on one or more individual model(s), and/or the like. In some embodiments, the real-time data central learning system 102 maintains a historical data repository 410 including the central model, accuracy data associated with the central model, data received and/or generated associated with training the central model, and/or the like. Additionally or alternatively, in some embodiments, the historical data repository 410 includes data embodying, used to facilitate, or otherwise associated with connections currently or previously formed with one or more external computing device(s) (e.g., the AI robots 106A-106N). In some embodiments, the historical data repository 410 maintains data previously generated, collected, and/or received by each of the AI robots 106A-106N, and that may be used to re-train a central model based at least in part on such data. For example, in some embodiments, the historical data repository 410 may include sets of sensor data associated with each AI robot of the AI robots 106, previously received updated individual models from each of the AI robots 106, previously received accuracy data associated with updated individual model(s) received from each of the AI robots 106, error data objects received associated with each of the AI robots 106, and/or the like. In this regard, in a circumstance where a central model is generated and/or maintained that diminishes in accuracy or does not meet a minimum accuracy threshold, such data may be used to re-train a new central model based on a subset of such stored historical data. In some embodiments, the historical data repository 410 maintains accuracy data, error data objects, and/or other data embodying and/or associated with a central model maintained by the real-time data central learning system 102.

To maintain the central model, the real-time data central learning system 102 may further train the central model to generate an updated central model, for example the updated central model 406. In some embodiments, the real-time data central learning system 102 trains a currently maintained central model to generate the updated central model 406 based at least in part on received data associated with or embodying updated individual models associated with one or more external computing devices, for example updated individual models 404 received from one or more of the AI robots 106A-106N and/or additional data associated with the updated individual models 404 received from one or more of the AI robots 106A-106N. In one example context, the real-time data central learning system 102 utilizes the updated individual models 404 to further train a stored central model utilizing federated learning, thus generating the updated central model 406. The updated central model 406 may thus represent improvements, data patterns, and/or other elements learned by one or more of the updated individual models 404. By leveraging each of the updated individual models 404 for use in federated learning, the real-time data central learning system 102 advantageously generates the updated central model 406 in a manner that learns various improvements that may have been learned by only one or a subset of the updated individual models 404.

The real-time data central learning system 102 may store the updated central model 406, for example in the historical data repository 410, for subsequent use. For example, the updated central model 406 may be stored as the new central model, such that subsequent updates are performed with respect to the updated central model 406. The updated central model 406 may be pushed to one or more individual robot(s) for use, and a previous version of the central model may be stored (e.g., in the historical data repository 410), or deleted. In this regard, the real-time data central learning system 102 advantageously performs such that the central model maintained by the real-time data central learning system 102 may continuously improve based at least in part on the improvements learned by any one or more of the updated individual models 404.

In some embodiments, the real-time data central learning system 102 distributes the updated central model 406 to one or more individual computing devices external to the real-time data central learning system 102. For example, the real-time data central learning system 102 may transmit the updated central model 406 to all or some of the AI robots 106A-106N for storage and/or subsequent use. In some embodiments, the real-time data central learning system 102 outputs or otherwise distributes the updated central model 406 based on one or more determination(s). For example, in some embodiments the real-time data central learning system 102 receives, maintains, and/or otherwise determines accuracy data for each of the updated individual models 404 currently utilized by an AI robot of the AI robots 106A-106N. The real-time data central learning system 102 may compare the accuracy data associated a particular updated individual model of the updated individual models 404 with accuracy data generated or otherwise determined with respect to the updated central model 406. In some such embodiments, the real-time data central learning system 102 may output or distribute the updated central model 406 to a particular AI robot in a circumstance where a difference between the accuracy of the updated individual model associated with that AI robot and the accuracy of the updated central model 406 is determined to exceed an update threshold, based at least in part on the comparison. In other embodiments, the real-time data central learning system 102 outputs or otherwise distributes the updated central model 406 to one or more AI robot(s) as such updates are completed.

Upon receiving the updated central model 406, each or some of the recipient AI robots may utilize the updated central model 406 for performing subsequent operations. In this regard, the AI robot(s) that receive the updated central model 406 advantageously may operate better (e.g., more efficiently, with less errors, and/or the like) based on the improvements learned during the last round of training the updated central model. Similarly, in circumstances where the updated central model 406 is trained in a federated manner (e.g., based at least in part on data associated with updated individual models maintained individually by each of the AI robots 106A-106N), each AI robot that receives and utilizes the updated central model 406 advantageously may utilize the model to take advantage of improvements learned by other AI robots of the AI robots 106A-106N. For example, in circumstances where the AI robots 106A-106N embody a fleet of AI robots within a particular environment, each of the AI robots 106A-106N may learn improvements from its particular operations. Similarly, such learned improvements may be represented in the updated central model 406 based at least in part on the training via federated learning, such that upon redeployment of the updated central model 406 the other AI robots of the AI robots 106A-106N may similarly advantageously leverage such improvements without having learned such improvements from its own operations. In other words, the AI robots 106A-106N may each learn from the improvements and errors detected and/or otherwise experienced by each of the other AI robots 106A-106N. Additionally, utilizing one or more high-throughput communications network(s), such federated learning and distribution may occur in real-time, or as near-real-time as possible, to advantageously enable the AI robots 106A-106N to continuously improve without requiring delayed and/or batched updating to occur at a future timestamp.

Subsequently, upon redeployment of the updated central model 406, the AI robots 106A-106N may store an instance of the updated central model 408 as its new individual model. Subsequently, each AI robot of the AI robots 106A-106N may continue to update its instance of the updated central model 408 as its own newly updated individual model. In this regard, advantageously the data flow depicted and described with respect to FIG. 4 may cyclically repeat any number of times. For example, in some embodiments, the data flow is continuously performed, such that the AI robots 106A-106N continuously and in real-time and/or near-real-time advantageously may leverage the improvements learned by the other AI robots.

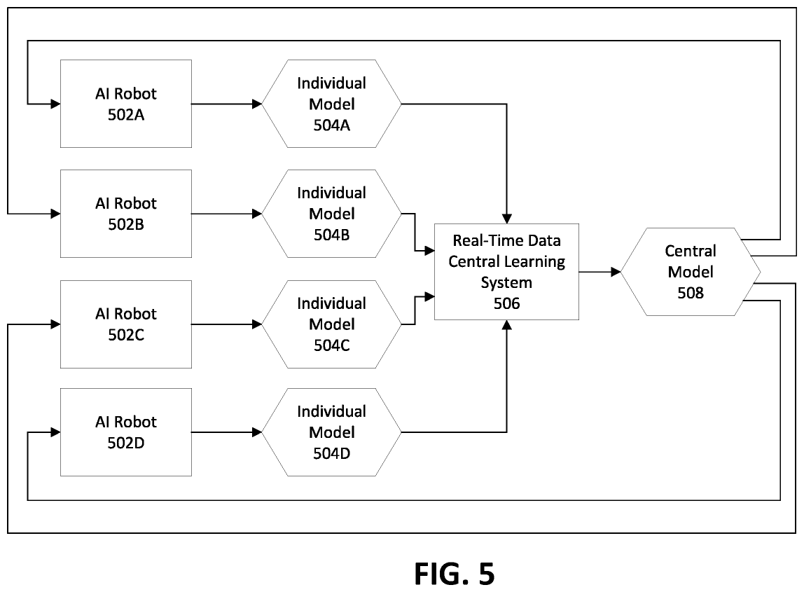

FIG. 5 illustrates an example representation of data flows for model updating based at least in part on a plurality of local models in accordance with at least some example embodiments of the present disclosure. Specifically, FIG. 5 depicts generation of a central model based at least in part on a plurality of individual models associated with a plurality of AI robots. In this regard, as illustrated and described, a central model is generated based at least in part on a federated learning process that learns from the independent features represented in each of the plurality of individual models. In some embodiments, the central model is redeployed to one or more AI robots for subsequent use upon generation. In this regard, the depicted data flow may be cyclically repeated any number of times, and/or indefinitely, to enable continuous regeneration and redeployment of a central model upon updating of one or more of the individual models. By continuously updating the central model as described, the described data flow enables improved operation of the individual models based on generation of each updated central model.

It will be appreciated that, in some embodiments, a central model is generated and/or regenerated for a particular type of model. In this regard, one or more AI robot(s) may maintain a plurality of different types of individual models (e.g., a first individual model for perception, and a second individual model for initiating interaction with an environment). In some such embodiments, a central model may be generated corresponding to each particular type of model based on the individual models corresponding to that model type. For example, a first central model may be generated (and/or regenerated during updating) corresponding to a first type of individual model (e.g., a perception model) based on a plurality of individual models of the first type, and a second central model may be generated (and/or regenerated during updating) corresponding to a second type of individual model (e.g., an interaction model) based on a plurality of individual models of the second type. The first central model may subsequently replace one or more of the individual models of the first type, the central model may subsequently replace one or more of the individual models of the second type, and so on for any of a myriad of additional model types.

As illustrated, a plurality of AI robots 502A-502D (collectively “AI robots 502”) may each maintain an individual model, for example individual models 504A-504D (collectively “individual models 504.” In this regard, the individual model corresponding to each of the AI robots 502 may be maintained independently and updated based on the particular functioning of the corresponding AI robot, data received and/or processed by the corresponding AI robot, error data objects resulting from processing and/or operation of the corresponding AI robot, and/or the like. For example, AI robot 502A may store and maintain individual model 504A, AI robot 502B may store and maintain individual model 504B, AI robot 502C may store and maintain individual model 504C, and AI robot 502D may store and maintain individual model 504D. In one example context, each of the AI robots 502A utilizes the corresponding individual model of the individual models 504 to process real-time sensor data for purposes of environment perception and/or initiating interaction with said environment. Additionally, in some embodiments, as the AI robots 502 operate, each detects error(s) resulting from operation based at least in part on results data generated from the corresponding individual model of the individual models 504. An error may include a failed operation, a detected drop of an item, and/or other undesired situation determinable based at least in part on real-time sensor data representing one or more aspects of the environment. Upon detecting an error, an AI robot of the AI robots 502 may generate an error data object representing the occurrence of the error and/or providing data indicative of the error that occurred. In some such embodiments, the AI robot updates the corresponding individual model of the individual models 504 based at least in part on such generated error data objects. In other contexts, it will be appreciated that error data objects may be generated in another manner. For example, error data objects may be determined based at least in part on results data generated from the individual model of the individual models and comparison with expected data. Alternatively or additionally, in some embodiments, an AI robot of the AI robots 502 updates the corresponding individual model of the individual models 504 based at least in part on real-time sensor data captured and/or otherwise received by the AI robot. In this regard, as each of the AI robots 502 functions, the individual model associated with the said AI robot is updated to improve the functionality of the AI robot and reduce occurrence of errors.

The AI robots 502 communicate their respective individual model of the individual models 504 to the real-time data central learning system 506 for processing, such as to generate a central model based at least in part on the individual model. In some embodiments, a particular AI robot transmits its corresponding individual model to the real-time data central learning system 506 upon completion of generating and/or updating the individual model. For example, the AI robot 502A operates and updates the individual model 504A, and continuously and/or in real-time transmits data embodying and/or associated with the individual model 506A upon completion of updating the individual model 504A. Similarly, the AI robot 502C operates independently from the other AI robots 502 and updates the corresponding individual model 504C. The AI robot 502C may subsequently continuously and/or in real-time transmit data embodying and/or associated with the individual model 504C upon completion of updating the individual model 504C. In this regard, the real-time data central learning system 506 may continuously and/or in real-time, or near-real-time, receive any number of individual models, such as via a high-throughput communications network.

Additionally or alternatively, in some embodiments, the AI robots 502 each provide accuracy data associated with its individually maintained individual model. For example, the AI robot 502A may transmit, to the real-time data central learning system 506, accuracy data associated with the individual model 504A, the AI robot 502B may transmit accuracy data associated with the individual model 504B, and so on. In some embodiments, the real-time data central learning system 506 independently stores such accuracy data for each individual model of the individual models 504. For example, received accuracy data may be stored associated with a data identifier that uniquely identifies the AI robot of the AI robots 502 associated with a corresponding individual model, such as the AI robot that transmitted the associated individual model and/or the accuracy data itself.

The real-time data central learning system 506 may store the received data embodying or associated with individual models as they are updated for use in subsequent processing. For example, in some embodiments, the real-time data central learning system 506 utilizes the received data embodying and/or associated with the individual models to generate, maintain, and/or otherwise update a updated central model 508. In one example context, the real-time data central learning system 506 receives data embodying and/or associated with the individual models 504 in real-time and/or continuously as such models are updated, and utilizes such data embodying and/or associated with the individual models 504 to update the updated central model 508 utilizing federated learning. For example, in some contexts the real-time data central learning system 506 may receive data embodying the individual models 504, and process the data embodying the individual models 504 to update parameters and/or hyperparameters of the updated central model 508 to reflect patterns, trends, and/or the like learned from the combination of individual models 504. Alternatively or additionally, in some contexts, the real-time data central learning system receives data embodying error data objects resulting from operations of the individual models 504. In some such contexts, the real-time data central learning system 506 may process such error data object(s) to update the updated central model 508 in a manner that reduces the likelihood of generating results data that, upon processing, results in the error represented by and/or otherwise corresponding to the error data object.

In some embodiments, upon updating and/or generating the updated central model 508, the real-time data central learning system 506 transmits and/or otherwise provides the updated central model 508 to one or more AI robots for subsequent processing and/or use. For example, in some embodiments, upon completing the training of the updated central model 508, the real-time data central learning system 506 provides the updated central model 508 to each AI robot of the AI robots 502 with which the real-time data central learning system 506 communicates. Alternatively or additionally, in some embodiments, upon completing the training of the updated central model 508, the real-time data central learning system 506 provides the updated central model 508 to each AI robot that provided an individual model for facilitating update of the updated central model 508. In some embodiments, the real-time data central learning system 506 provides the updated central model 508 to one or more AI robots, such as one or more of the AI robots 502, via one or more high-throughput communications network(s). The real-time data central learning system 506 may access the high-throughput communications network(s) to provide the updated central model 508 to one or more of the AI robots 502 continuously and/or in real-time or near-real-time upon receiving the individual models 504 and/or upon completing training of the updated central model 508.

In some embodiments, the real-tie data central model 506 distributes the central model 508 to one or more of the AI robots 502 in real-time, or near-real-time, as the updating of the central model 508 is completed. Alternatively or additionally, in some embodiments, the real-time data central learning system 506 distributes the central model 508 to one or more of the AI robots 502 upon one or more met condition(s), determination(s), and/or the like. For example, in some embodiments, the real-time data central learning system 506 generates accuracy data associated with the central model 508 as it is updated. In some embodiments, the real-time data central learning system 506 compares the accuracy data associated with one of the individual models 504 with accuracy data associated with the central model 508 to determine whether and/or how much the central model 508 performs better than the individual model. In some embodiments, the real-time data central learning system transmits the central model 508 to the AI robot corresponding to the individual model in a circumstance where the real-time data central learning system 506 determines the accuracy data associated with the central model 508 exceeds or otherwise satisfies an update threshold (e.g., indicating the central model 508 has improved over the individual model sufficiently enough that the central model 508 should be distributed). Alternatively or additionally still, in some embodiments, the real-time data central learning system 506 distributes the central model 508 to some or all of the AI robots 502 at particular predetermined timestamp intervals (e.g., hourly, daily, and/or at another predefined timestamp interval). Alternatively or additionally still, in some embodiments, the real-time data central learning system 506 tracks the time since the individual model maintained by each AI robot of the AI robots 502 was previously updated, and distributes the central model 508 in a circumstance where the last update of the individual model for a particular AI robot exceeds a maximum timestamp threshold (e.g., update minimum once a day, once an hour, or the like).

A particular AI robot may utilize the received updated central model 508 to replace an individual model currently maintained by the particular AI robot and/or determining whether to replace the individual model currently maintained by the particular AI robot. In some embodiments, upon receiving the updated central model 508 for example, some or all of the AI robots 502 replace the individual model maintained by the AI model with the received updated central model 508. For example, in some embodiments, the AI robot 502A, AI robot 502C, and/or other AI robots of the AI robots 502 automatically replace the maintained individual model with the newly received updated central model 508. In some embodiments, one or more AI robots of the AI robots 502 processes the updated central model 508 to determine and/or otherwise select a preferred model between the currently maintained individual model and the newly received updated central model 508. For example, in some embodiments, the AI robot 502D receives the updated central model 508 and receives and/or determines accuracy data associated with the updated central model 508. The accuracy data may indicate the likelihood of the updated central model 508 producing an error and/or results data that, upon processing by the AI robot 502D, may result in an error. Additionally or alternatively, the AI robot 502D may retrieve and/or identify accuracy data associated with the individual model 504D currently maintained by the AI robot 502D, where such accuracy data similarly indicates a likelihood of the individual model 504D producing an error and/or results data that, upon processing by the AI robot 502D, may result in an error.

The AI robot 502D may compare data associated with the individual model 504D with data associated with the updated central model 508 to select a preferred model between the two. For example, in some embodiments the AI robot 502D compares accuracy data associated with updated central model 508 with accuracy data associated with the individual model 504D to determine which model is more accurate. In some such embodiments, the AI robot 502D may select the more accuracy model as the preferred model for further use based at least in part on the results of the comparison. In some embodiments, the AI robot 502D maintains only the preferred model, such that the AI robot 502D replaces the individual model 504D with the updated central model 508 in a circumstances where the updated central model 508 is determined to be more accurate and/or otherwise selected. Such embodiments may ensure that the AI robots 502 continuously maintain the model(s) that are most likely to enable each of the AI robots 502 to accurate perform one or more operations based at least in part on use of the model(s).

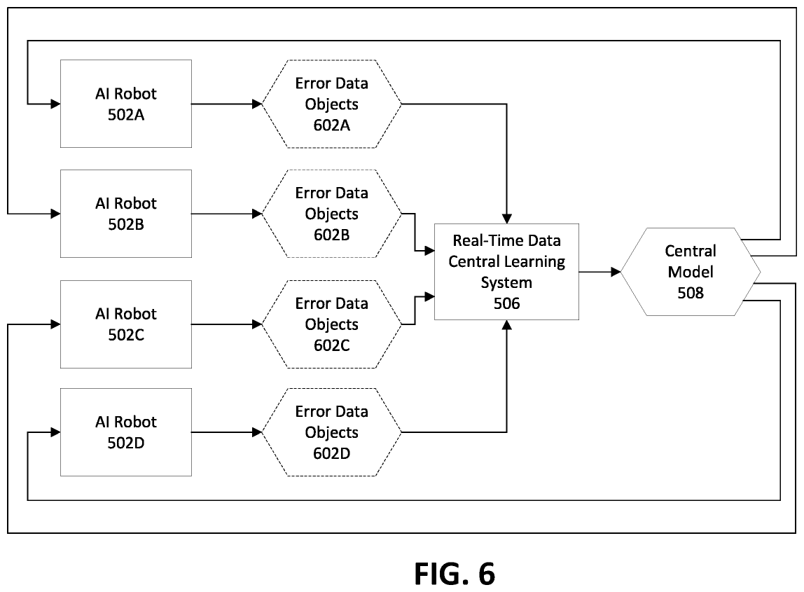

FIG. 6 illustrates an example representation of data flows for model updating based at least in part on error data objects in accordance with at least some example embodiments of the present disclosure. Specifically, FIG. 5 illustrates communication between AI robots 502 and the real-time data central learning system 506 to transmit error data object(s) from each of the one or more AI robots 502 to the real-time data central learning system 506 for use in generating and/or updating a updated central model 508 for use and/or distribution to one or more of the AI robots 502. It should be appreciated that the similarly named components may function in a manner similar to that described herein with respect to the similarly named components of FIG. 5. Accordingly, for purposes of brevity and clarity, repeated disclosure of such functionality is omitted.

Each of the AI robots generates one or more error data objects for further processing. For example, as illustrated, the AI robot 502A generates and/or otherwise is associated with error data objects 602A, the AI robot 502B generates and/or otherwise is associated with error data objects 602B, the AI robot 502C generates and/or otherwise is associated with the error data objects 602C, and/or the AI robot 502D generates and/or otherwise is associated with the error data objects 602D. Each of the error data objects 602A, 602B, 602C, and 602D (collectively “error data objects 602”) may be embodied by one or more individual error data object(s), and/or a set, list, and/or other grouping of a plurality of data objects generated associated with operations and/or processing of the corresponding AI robot.

Each AI robot may generate an error data object of the error data objects 602 upon on detecting an error in operation and/or processing of the AI robot. For example, the AI robot 502A may generate the error data objects 602A representing errors in operation and/or processing of the AI robot 502A during application of real-time sensor data to an individual model maintained by the AI robot 502A, such as the updated individual model 504A. Such errors may be detected in response to identifying erroneous results data that does not match expected results data, and/or may correspond to a failed operation, failed interaction with the environment, and/or the like detected by the AI robot 502A. In one example context, the AI robot 502A utilizes an individual model, such as the individual model 504A, to generate results data that is utilized in implementing a particular process for interacting with an environment to complete a task operation (e.g., removing an item for movement to another location). The AI robot 502A may erroneously complete the task operation or otherwise fail the interaction in any of a myriad of manners (e.g., by implementing processes for picking up the item based at least in part on results data generated by the individual model 504A, but dropping the item). Upon detecting the error by the AI robot 502A (e.g., based at least in part on sensor data captured from the environment), the AI robot 502A may generate an error data object of the error data objects 602 that represents the detected error, the results data that caused the error, and/or the like. It will be appreciated that any number of errors may result from a single interaction and/or a plurality of interactions over any period of time. In this regard, each of the AI robots 502 may operate independently and generate error data objects of the corresponding error data objects 602 based at least in part on error(s) detected during such operations.

In some embodiments, an AI robot generates an error data object comprising a set of sensor data that was processed and resulted in an error. For example, in some embodiments where the AI robot captures and/or receives particular sensor data (e.g., an environment perception data set) that is processed by the individual model maintained by the AI robot to generate results data and/or initiate an operation, the AI robot identifies a subset of said sensor data that was utilized to generate results data that embodied or otherwise caused an error. In one such example context, AI robot 502C may process a particular environment perception data set by applying some or all of such data to the individual model 504C maintained by the AI robot 502C as described in FIG. 5. In a circumstance where the individual model 504C processes at least a subset of the environment perception data set to initiate one or more operations, an error data object may be generated that embodies at least the subset of the environment perception data set that resulted in an erroneous or failed operation. By transmitting the error data objects, a real-time data central learning system 506 may further train and/or update a central model 508 to similarly learn from the actual errors independently experienced by the AI robots 502. In some such embodiments, the real-time data central learning system 506 may sufficiently learn from such error data objects and each AI robot may not transmit its individual model itself.

In some embodiments, the AI robots 502A, 502B, 502C, and/or 502D transmit at least data embodying the corresponding error data objects 602A, 602B, 602C, and/or 602D, as such error data objects are generated. In this regard, the real-time data central learning system 506 may continuously and/or in real-time or near-real-time receive one or more of the error data objects 602 as such error data objects are generated. In this regard, the real-time data central learning system 506 is capable of processing the received error data objects 602 in real-time or near-real-time as such error data objects are generated. Similarly, the real-time data central learning system 506 may learn from such error data objects 602 (e.g., by processing the error data objects 602 to update the updated central model 508 as described) in real-time and/or near-real-time. In such embodiments, the real-time or near-real-time transmission of each of the error data objects 602A, 602B, 602C, and/or 602D enables continuous, real-time or near-real-time training of the updated central model 508 based at least in part on such error data objects, and subsequent redeployment of the updated central model 508 to one or more of the AI robots 502 for use.

### Example Processes of the Disclosure

Having described example systems, apparatuses, environments, data flows in accordance with the present disclosure, example processes in accordance with the present disclosure will now be discussed. It will be appreciated that each of the flowcharts depicts an example computer-implemented process that may performed by one or more of the apparatuses, systems, devices, and/or computer program products described herein, for example using one or more of the specially configured components thereof. The blocks depicted indicate operations of each process. Such operations may be in any of a number of ways, including, without limitation, in the order and manner as depicted and described herein. In some embodiments, one or more blocks of any of the processes described herein occur in-between one or more blocks of another process, before one or more blocks of another process, in parallel with one or more blocks of another process, and/or as a sub-process of a second process. Additionally or alternatively, any of the processes may include some or all operational steps described and/or depicted, including one or more optional blocks in some embodiments. With regard to the flowcharts illustrated herein, one or more of the depicted blocks may be optional in some, or all, embodiments of the disclosure. Optional blocks are depicted with broken (or “dashed”) lines. Similarly, it should be appreciated that one or more of the operations of each flowchart may be combinable, replaceable, and/or otherwise altered as described herein.

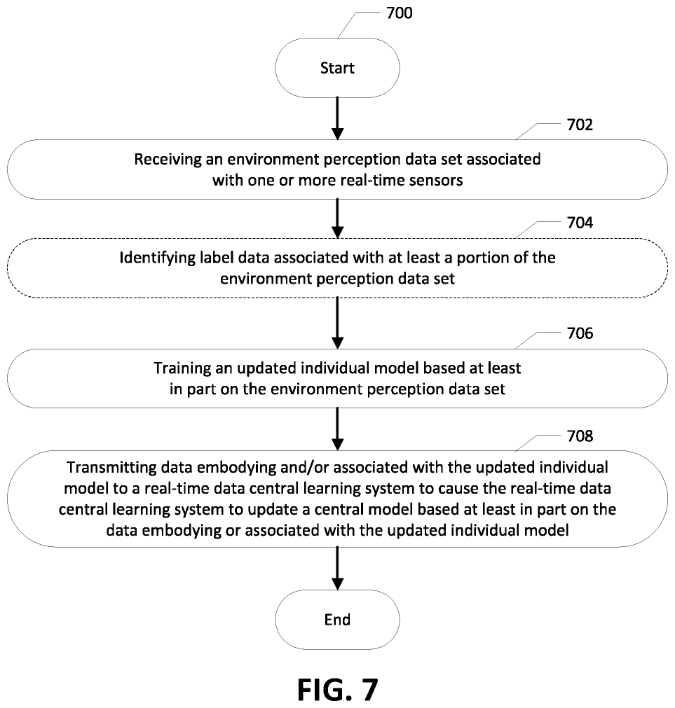

FIG. 7 illustrates a flowchart depicting example operations of an example process for improved model training in accordance with at least some example embodiments of the present disclosure. Specifically, FIG. 7 illustrates operations of an example process 700. In some embodiments, the example process 700 is embodied by computer program code stored on a non-transitory computer-readable storage medium of a computer program product configured for execution to perform the process as depicted and described. Alternatively or additionally, in some embodiments, the process 700 is performed by one or more specially configured computing devices, such as the AI robot apparatus 200 alone or in communication with one or more other component(s), device(s), system(s), and/or the like. In this regard, in some such embodiments, the AI robot apparatus 200 is specially configured by computer-coded instructions (e.g., computer program instructions) stored thereon, for example in the memory 204 and/or another component depicted and/or described herein and/or otherwise accessible to the AI robot apparatus 200, for performing the operations as depicted and described. In some embodiments, the AI robot apparatus 200 is in communication with one or more external apparatus(es), system(s), device(s), and/or the like, to perform one or more of the operations as depicted and described. For example, the AI robot apparatus 200 may be in communication with any number of real-time sensor(s), real-time data central learning systems (e.g., embodied by a central learning apparatus 250), other AI robot(s), and/or the like. For purposes of simplifying the description, the process 700 is described as performed by and from the perspective of an AI robot apparatus 200, for example embodying a particular AI robot within a particular environment.

The process 700 begins at operation 702. At operation 702, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to receive an environment perception data set associated with one or more real-time sensors. The environment perception data set may include any number of individual portions of sensor data received from any of the one or more real-time sensors. Additionally or alternatively, the environment perception data set may include any number of different sensor data types (e.g., image data, LiDAR data, motion data, location data, and/or the like). Portions of sensor data embodying the environment perception data set may be received from real-time sensors onboard the AI robot apparatus 200, external to the AI robot apparats 200, and/or any combination thereof.

In some embodiments, the environment perception data set includes one or more portions of sensor data captured by real-time sensors embodied onboard the AI robot apparatus 200. For example, in some embodiments, the AI robot apparatus 200 includes one or more onboard real-time sensors that are activated to capture the environment perception data set. It will be appreciated that the real-time sensors onboard the AI robot apparatus 200 may be of the same sensor type and/or different sensor types than one or more other real-time sensors external to the AI robot apparatus 200. For example, the AI robot apparatus 200 may include one or more LiDAR sensors, video sensors, motion sensors, ranging sensors, and/or the like, utilized to capture portions of the environment perception data set.

In some embodiments, the environment perception data set embodies real-time or near-real-time sensor data representing one or more aspect(s) of a particular environment. In some embodiments, the environment perception data set is received via one or more high-throughput communications network(s). The high-throughput communications network(s) may enable transmission of high-fidelity sensor data embodied in the environment perception data set continuously as such data is captured, and in real-time or near-real-time without diminishing the quality, data size, and/or otherwise reducing the sensor data. In some embodiments, the high-throughput communications network(s) include one or more 5G communication network(s), or one or more Wi-Fi 6 enabled communication network(s).

At optional operation 704, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to identify label data associated with at least a portion of the environment perception data set. In some embodiments, label data is received to utilize such environment perception data set for directly training one or more models. For example, the label data may indicate particular objects, items, and/or other aspects of the environment to be detected via one or more model(s) via processing of such sensor data portion(s) of the environment perception data set. In some embodiments, the label data is retrieved from a particular data repository maintained by and/or otherwise accessible to the AI robot apparatus (e.g., a historical data repository). Alternatively or additionally, in some embodiments, the label data is received in response to user input manually providing such label data. It will be appreciated that, in some other embodiments such as where label data is not utilized to train one or more model(s) and/or such model(s) are not trained directly based on the sensor data of the environment perception data set, the AI robot apparatus 200 need not identify such label data (e.g., in implementations where error data is used to train one or more model(s) as described herein).

At operation 706, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to train an updated individual model based at least in part on the environment perception data set. In some embodiments, the AI robot apparatus 200 trains an updated individual model by updating a currently maintained individual model based at least in part on the environment perception data set and label data associated with one or more portion(s) of the environment perception data set. In some such embodiments, the AI robot apparatus 200 may update the training of the individual model to reflect or otherwise learn from patterns, trends, and/or the like represented in the environment perception data set based at least in part on the label data, thus yielding the updated individual model.

Alternatively or additionally, in some embodiments, the AI robot apparatus 200 generates one or more error data objects for use in training the updated individual model. For example, in some embodiments, the AI robot apparatus 200 applies some or all of the environment perception data set to an individual model before further training of said individual model. The individual model may produce results data based at least in part on the portion(s) of the environment perception data set applied to the individual model. In some embodiments, the AI robot apparatus 200 generates error data objects based at least in part on processing the results data from the individual model. For example, the AI robot apparatus 200 may determine whether the results data matches expected results data (e.g., retrieved from a data repository, received from an external computing device, real-time data central learning system, and/or the like), and detect an error in the circumstance where a comparison indicates the results data does not match the expected results data. Additionally or alternatively, in some embodiments, the AI robot apparatus 200 utilizes the results data to initiate and/or otherwise perform one or more process(es) based at least in part on such results data, for example operation(s) for interacting with an environment associated with the AI robot apparatus 200. In some such embodiments, the AI robot apparatus 200 may detect whether such process(es) are performed successfully, fail, or otherwise are performed with errors. In some embodiments, the AI robot apparatus 200 generates error data object(s) representing detected errors in the results data, operations, and/or the like.

The AI robot apparatus 200 may subsequently train the updated individual model based at least in part on the generated error data object(s). For example, in some embodiments, the AI robot apparatus 200 trains the individual model to generate alternative results data determined likely to reduce the likelihood of an error. In some embodiments, the AI robot apparatus 200 trains the individual model to produce the updated individual model that reduces the likelihood of receiving the same results data based at least in part on the portion(s) of the environment perception data set utilized to generate such results data. It will be appreciated that the AI robot apparatus 200 may implement any of a myriad of known reinforcement learning and/or other task-oriented learning algorithms to train an individual model and generate the updated individual model therefrom.

At operation 708, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to transmit data embodying and/or associated with the updated individual model to a real-time data central system to cause the real-time data central learning system to update a central model based at least in part on the data. In some embodiments, the data embodying and/or associated with the updated individual model is transmitted in real-time upon completion of training the updated individual model. The AI robot apparatus 200 may transmit the data embodying and/or associated with the updated individual model via a high-throughput communications network accessible to the AI robot apparatus 200 and the real-time data central learning system. In this regard, the transmission of the data embodying and/or associated with the updated individual model may automatically cause the real-time data central learning system to initiate one or more process(es) for updating the central model based at least in part on such data. As described herein, the central model may be updated based at least in part on the data embodying and/or associated with the updated individual model and/or other data embodying and/or associated with other updated individual models for other AI robots in or associated with the environment.

In some embodiments, the AI robot apparatus 200 transmit the updated individual model itself to the real-time data central learning system. In some such embodiments, the real-time data central learning system may update the central model based at least in part on one or more parameters, hyperparameters, features, and/or other portions of the updated individual model to learn data trends, patterns, and/or the like represented in the updated individual model. Alternatively or additionally, in some embodiments, the AI robot apparatus 200 transmits error data object(s) associated with training the updated individual model. In this regard, the real-time data central learning system may process and learn directly from such error data object(s), and/or the data embodying the updated individual model itself, to train the updated central model to reduce the likelihood of such errors. Additionally or alternatively, in some embodiments, the AI robot apparatus 200 transmits at least a portion of the environment perception data set, and/or associated label data, to the real-time data central learning system. In some such embodiments, the real-time data central learning system may process and learn directly from the environment perception data set, and/or associated label data, to improve the accuracy of the central model. It will be appreciated that utilizing any such data, the real-time data central learning system may update a central model to produce the updated central model based at least in part on a federated learning process that utilizes such data from various AI robots, for example each embodied by an AI robot apparatus 200. It will be appreciated that, in some embodiments, the AI robot apparatus 200 only transmits detected and/or generated error data object(s) for processing by the real-time data central learning system.

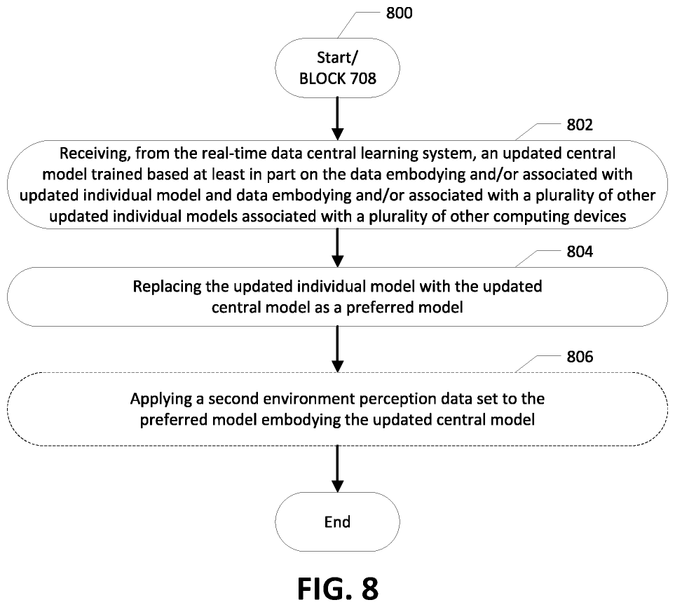

FIG. 8 illustrates a flowchart depicting example operations of an example process for replacing an updated individual model with an updated central model in accordance with at least some example embodiments of the present disclosure. Specifically, FIG. 8 depicts operations of an example process 800. In some embodiments, the process 800 is embodied by computer program code stored on a non-transitory computer-readable storage medium of a computer program product configured for execution to perform the process as depicted and described. Alternatively or additionally, in some embodiments, the process 800 is performed by one or more specially configured computing devices, such as the AI robot apparatus 200. Such computing devices may perform the operations of the described processes alone or in communication with one or more other component(s), device(s), system(s), and/or the like. In this regard, in some such embodiments, the computing device(s) is/are specially configured by computer-coded instructions (e.g., computer program instructions) stored thereon, for example in a memory and/or another component depicted and/or described herein and/or otherwise accessible to the computing device(s), for performing the operations as depicted and described. In some embodiments, the computing device(s) is/are in communication with one or more external apparatus(es), system(s), device(s), and/or the like, to perform one or more of the operations as depicted and described. For example, in one example context, the AI robot apparatus 200 is in communication with one or more real-time sensors, a real-time data central learning system, and/or the like. For purposes of simplifying the description, the process 800 is described as performed by and from the perspective of the AI robot apparatus 200.

The process 800 begins at operation 802. In some embodiments, the process 800 begins after one or more operations depicted and/or described with respect to any of the other processes described herein. For example, in some embodiments as depicted, the process 800 begins after execution of operation 708. In this regard, some or all of the process 800 may replace or supplement one or more blocks depicted and/or described with respect to any of the other processes described herein. Upon completion of the process 800, the flow of operations may terminate. Additionally or alternatively, in some embodiments, upon completion of the process 800, flow may return to one or more operations of another process. For example, in some embodiments, the process 700 restarts upon completion of the process 800. It should be appreciated that, in some embodiments, the process 800 embodies a subprocess of one or more other process(es), such as the process 700.

At operation 802, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to receive, from the real-time data central learning system, an updated central model. The updated central model may be trained based at least in part on the data embodying and/or associated with the updated individual model together with data embodying and/or associated with a plurality of other updated individual models. Each other updated individual model may be associated with one of a plurality of other computing devices, for example other AI robots within or otherwise associated with a particular environment. The updated central model may represent a particular model updated utilizing federated learning process(es) based at least in part on all received updated individual models for any number of computing devices. In this regard, the updated central model may embody or reflect learnings from each of the updated individual models that contributed to generating the updated central model.

In some embodiments, the AI robot apparatus 200 receives the updated central model via a high-throughput communications network. In some such embodiments, the AI robot apparatus 200 may receive the updated central model in real-time or near-real-time as the training of the updated central model is completed by the real-time data central learning system. Alternatively or additionally, in some embodiments the updated central model is received in a circumstance where the accuracy of the updated central model indicates an improvement over the accuracy of the updated individual model currently maintained by and/or otherwise associated with the AI robot apparatus 200. In some such embodiments, the real-time data central learning system may compare accuracy data determined for the updated central model with accuracy data for the updated individual model transmitted by the AI robot apparatus 200. The AI robot apparatus 200 may then receive the updated central model in a circumstance where the comparison between such accuracy data indicates an improvement that satisfies an update threshold. For example, in some embodiments, the real-time data central learning system determines a difference between the accuracy data for the updated individual model and the accuracy data for the updated central model, and pushes the updated central model to the AI robot apparatus 200 only in a circumstance where the difference in accuracy exceeds the update threshold.

At operation 804, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to replace the updated individual model with the updated central model as a preferred model. In some such embodiments, the AI robot apparatus 200 maintains a preferred model representing a particular data model to use for performing one or more subsequent operations (e.g., for processing subsequently received real-time sensor data during operation). In this regard, the preferred model may represents the current individual model particular to that AI robot apparatus 200 as it is utilized and/or updated locally. In some such embodiments, as the updated individual model is received, the AI robot apparatus 200 may store the updated central model as the preferred model such that the updated central model becomes the new individual model utilized and/or maintained by the AI robot apparatus 200.

At optional operation 806, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to apply a second environment perception data set to the preferred model embodying the updated central model. In this regard, the second environment perception data set may be applied to the preferred model embodying the updated central model for use in one or more operations. The updated central model may be improved and/or otherwise more accurate as compared to the previously maintained individual model based on the previous round of updating the central model. The AI robot apparatus 200 may apply the second environment perception data set to initiate one or more operation(s) via the updated central model, generate and/or process results data generated by the updated AI model, and/or the like.

In some embodiments, once the updated central model is assigned as the preferred model to the AI robot apparatus 200, the instance of the updated central model received by the AI robot apparatus 200 is maintained as the new individual model for said AI robot apparatus 200. For example, based at least in part on the second environment perception data set, subsequent captured environment perception data set(s), and/or the like, the AI robot apparatus 200 may continue to update the updated central model based on its own operation(s), error(s), and/or the like. As such, while a plurality of AI robots each embodied by an instance of the AI robot apparatus 200, for example, may receive the same updated central model at a particular timestamp, each AI robot may subsequently maintain and update their individual instance of the received updated central model such that the updated central model becomes the individual model for each AI robot. In this regard, in some such embodiments, the process 700 subsequently may restart for one or more AI robot(s) embodied by the AI robot apparatus 200 as such updates are performed at the level of each individual AI robot maintaining a preferred model as the individual model for said AI robot.

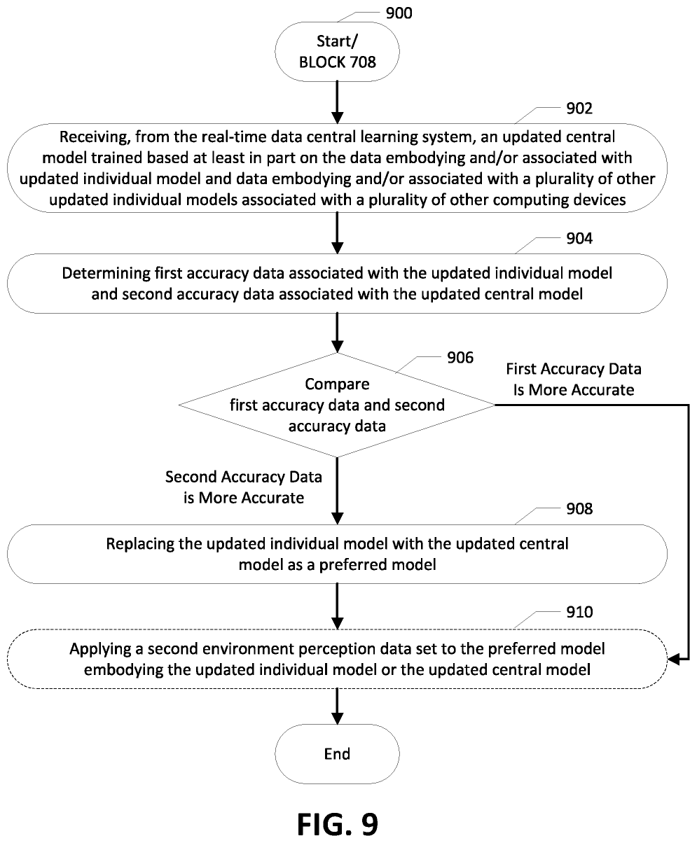

FIG. 9 illustrates a flowchart depicting example operations of an example process for setting a preferred model in accordance with at least some example embodiments of the present disclosure. Specifically, FIG. 9 depicts operations of an example process 900. In some embodiments, the process 900 is embodied by computer program code stored on a non-transitory computer-readable storage medium of a computer program product configured for execution to perform the process as depicted and described. Alternatively or additionally, in some embodiments, the process 900 is performed by one or more specially configured computing devices, such as the AI robot apparatus 200. Such computing devices may perform the operations of the described processes alone or in communication with one or more other component(s), device(s), system(s), and/or the like. In this regard, in some such embodiments, the computing device(s) is/are specially configured by computer-coded instructions (e.g., computer program instructions) stored thereon, for example in a memory and/or another component depicted and/or described herein and/or otherwise accessible to the computing device(s), for performing the operations as depicted and described. In some embodiments, the computing device(s) is/are in communication with one or more external apparatus(es), system(s), device(s), and/or the like, to perform one or more of the operations as depicted and described. For example, in one example context, the AI robot apparatus 200 is in communication with one or more real-time sensors, a real-time data central learning system, and/or the like. For purposes of simplifying the description, the process 900 is described as performed by and from the perspective of the AI robot apparatus 200.

The process 900 begins at operation 902. In some embodiments, the process 900 begins after one or more operations depicted and/or described with respect to any of the other processes described herein. For example, in some embodiments as depicted, the process 900 begins after execution of operation 708. In this regard, some or all of the process 900 may replace or supplement one or more blocks depicted and/or described with respect to any of the other processes described herein. Upon completion of the process 900, the flow of operations may terminate. Additionally or alternatively, in some embodiments, upon completion of the process 900, flow may return to one or more operations of another process. For example, in some embodiments, the process 700 restarts upon completion of the process 900. It should be appreciated that, in some embodiments, the process 900 embodies a subprocess of one or more other process(es), such as the process 700.

At operation 902, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to receive, from the real-time data central learning system, an updated central model. The updated central model may be trained based at least in part on the data embodying and/or associated with the updated individual model together with data embodying and/or associated with a plurality of other updated individual models. Each other updated individual model may be associated with one of a plurality of other computing devices, for example other AI robots within or otherwise associated with a particular environment. The updated central model may represent a particular model updated utilizing federated learning process(es) based at least in part on all received updated individual models for any number of computing devices. In some embodiments, the AI robot apparatus 200 receives the updated central model via a high-throughput communications network. For example, the AI robot apparatus 200 may receive the updated central model in real-time or near-real-time as the training of the updated central model is completed by the real-time data central learning system.

At operation 904, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to determine first accuracy data associated with the updated individual model for the AI robot apparatus 200 and second accuracy data associated with the updated central model. The first accuracy data may represent a determined or predicted accuracy of the results data generated by the updated individual model with respect to one or more goal metric(s). Similarly, the second accuracy data may represent a determined or predicted accuracy of the results data generated by the updated central model with respect to the same one or more goal metric(s). In one example context, such accuracy data represents the likelihood of the model produces data that does not represent or otherwise result in an error.

In some embodiments, generates the first accuracy data by applying a test data set to the updated individual model, and/or generates the second accuracy data by applying the test data set to the updated central model. Alternatively or additionally, in some embodiments, the AI robot apparatus 200 generates and stores the first accuracy data associated with the model during training of the updated individual model, and retrieves the first accuracy data associated with the updated individual model for comparison upon receiving the updated central model. Additionally or alternatively, in some embodiments, the AI robot apparatus 200 receives the second accuracy data associated with the updated central model from the real-time data central learning system. The second accuracy data may be received together with the updated central model and/or in a subsequent transmission.

At operation 906, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to compare the first accuracy data and the second accuracy data. The AI robot apparatus 200 may compare the first accuracy data and the second accuracy data to determine which represents a better accuracy. In some embodiments, the AI robot apparatus 200 utilizes one or more model comparison algorithms to determine which of the first accuracy data and the second accuracy data represents a better accuracy. In some embodiments, the first accuracy data and the second accuracy data represent a confidence score, such that the higher confidence score indicates the more accurate model. It will be appreciated that the AI robot apparatus 200 may utilize any of a myriad of model comparison algorithms known in the art.

In some embodiments, in circumstances where the AI robot apparatus 200 determines the first accuracy data is more accurate, the updated individual model remains the preferred model. In this regard, the updated individual model will remain in use for subsequent operations, and flow optionally proceeds to the operation 910, or ends. In circumstances where the AI robot apparatus 200 determines the second accuracy data is more accurate, flow proceeds to operation 908.

At operation 908, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to replace the updated individual model with the updated central model as a preferred model. In this regard, the AI robot apparatus 200 may maintain a preferred model that represents a model currently assigned for use and/or maintenance by the AI robot apparatus 200 in subsequent processing operations. In some embodiments, the AI robot apparatus 200 assigns the updated central model as the preferred model such that the AI robot apparatus 200 stores the updated central model for further use and/or maintenance. In some such embodiments, the AI robot apparatus 200 may delete and/or otherwise discard the updated individual model from memory. As the AI robot apparatus 200 makes updates to the instance of the updated central model newly assigned as the preferred model, the instance of the updated individual model maintained by the AI robot apparatus 200 diverges from other instances of the updated central model received and/or maintained by other AI robots. In this regard, the updated central model becomes the new individual model stored, used, and/or maintained by the AI robot apparatus 200.

At optional operation 910, the AI robot apparatus 200 includes means, such as the environment interaction circuitry 214, the real-time individual model learning circuitry 212, the sensor data intake circuitry 210, the communications circuitry 208, the input/output circuitry 206, the processor 202, and/or the like, or a combination thereof, to apply a second environment perception data set to the preferred model embodying either the updated individual model or the updated central model. In this regard, the second environment perception data set may be applied to the preferred model for subsequent use in one or more operations. The preferred model representing the updated central model (e.g., in circumstances where the accuracy of the updated central model was determined to be better) or the updated individual model (e.g., in circumstances where the accuracy of the updated individual model previously generated and/or maintained by the AI robot apparatus 200 was determined to be better) may be used to maximize the accuracy of subsequently performed operations and/or minimize errors. The AI robot apparatus 200 may apply the second environment perception data set to whichever model was assigned as the preferred model to initiate one or more operation(s), generate and/or process results data generated by the preferred model, and/or the like.

In some embodiments, the AI robot apparatus 200 maintains the preferred model as the new individual model for said AI robot apparatus 200. For example, based at least in part on the second environment perception data set, subsequent captured environment perception data set(s), and/or the like, the AI robot apparatus 200 may continue to update whichever model was assigned as the preferred model based at least in part on the AI robot apparatus' own operation(s), error(s), and/or the like. As such, while a plurality of AI robots each embodied by an instance of the AI robot apparatus 200, for example, may receive the same updated central model at a particular timestamp, each AI robot may determine whether or not to continue to use the updated individual model previously maintained by the AI robot or instead utilize the updated central model. Similarly, each AI robot embodied by an instance of the AI robot apparatus 200 may subsequently maintain and update their individual instance of whichever model is assigned as the preferred model, such that the assigned preferred model becomes the individual model for each AI robot. In this regard, in some such embodiments, the process 700 subsequently may be cyclically repeated for one or more AI robot(s) embodied by the AI robot apparatus 200 as such updates are performed at the level of each individual AI robot maintaining a preferred model as the individual model for said AI robot.

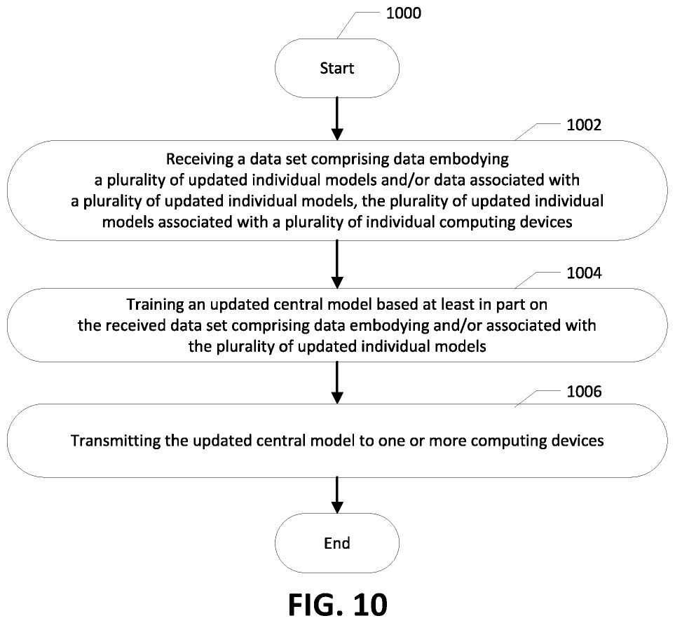

FIG. 10 illustrates a flowchart depicting example operations of an example process for training and transmitting an updated central model in accordance with at least some example embodiments of the present disclosure. Specifically, FIG. 10 depicts operations of an example process 1000. In some embodiments, the process 1000 is embodied by computer program code stored on a non-transitory computer-readable storage medium of a computer program product configured for execution to perform the process as depicted and described. Alternatively or additionally, in some embodiments, the process 1000 is performed by one or more specially configured computing devices, such as a real-time data central learning system 102 embodied by the central learning apparatus 250. Such computing devices may perform the operations of the described processes alone or in communication with one or more other component(s), device(s), system(s), and/or the like. In this regard, in some such embodiments, the computing device(s) is/are specially configured by computer-coded instructions (e.g., computer program instructions) stored thereon, for example in a memory and/or another component depicted and/or described herein and/or otherwise accessible to the computing device(s), for performing the operations as depicted and described. In some embodiments, the computing device(s) is/are in communication with one or more external apparatus(es), system(s), device(s), and/or the like, to perform one or more of the operations as depicted and described. For example, in one example context, the central learning apparatus 250 is in communication with one or more AI robots, real-time sensors, and/or the like. For purposes of simplifying the description, the process 1000 is described as performed by and from the perspective of the central learning apparatus 250, for example embodying a real-time data central learning system 102.

The process 1000 begins at operation 1002. In some embodiments, the process 1000 begins after one or more operations depicted and/or described with respect to any of the other processes described herein. For example, in some embodiments as depicted, the process 1000 begins after execution of operation 708. In this regard, some or all of the process 1000 may replace or supplement one or more blocks depicted and/or described with respect to any of the other processes described herein. Upon completion of the process 1000, the flow of operations may terminate. Additionally or alternatively, in some embodiments, upon completion of the process 1000, flow may return to one or more operations of another process. For example, in some embodiments, the process 700 restarts upon completion of the process 1000. It should be appreciated that, in some embodiments, the process 900 embodies a subprocess of one or more other process(es), such as the process 700.

At operation 1002, the central learning apparatus 250 includes means, such as the real-time central learning circuitry 262, the real-time model data intake circuitry 260, the communications circuitry 258, the input/output circuitry 256, the processor 252, and/or the like, or a combination thereof, to receive a data set comprising data embodying or associated with a plurality of updated individual models. The data set may be associated with a plurality of individual computing devices. For example, in some embodiments, the plurality of individual computing devices each maintain and transmit a particular updated individual model of the plurality of updated individual models. In some embodiments, the plurality of individual computing devices comprises a plurality of AI robots, each AI robot maintaining a particular model for operation and/or use.

In some embodiments, the central learning apparatus 250 receives the data set via one or more high-throughput communications network(s). The data set may be received in individual transmissions from each of the one or more plurality of individual computing devices. For example, in some embodiments, the central learning apparatus 250 receives first data embodying and/or associated with a first updated individual model from a first individual computing device of the plurality of individual computing devices, second data embodying and/or associated with a second updated individual model from a second individual computing device of the plurality of individual computing devices, and so on. In some such embodiments, the central learning apparatus 250 may receive each portion of the data set in real-time or near-real-time from a particular individual computing device upon completion of updating the individual model maintained by said individual computing device.

In some embodiments, the data set comprises data embodying each of the plurality of updated individual models. Additionally or alternatively, in some embodiments, the data set comprises error data object(s) representing error(s) detected based at least in part on operation of and/or results data generated by an associated updated individual model. For example, in some embodiments, the data set comprises only error data objects resulting from operation of each of the plurality of individual computing devices. Such error data objects may each include a subset of sensor data that was processed by an individual model associated with the individual computing device and resulted in a detected error. Additionally or alternatively, in some embodiments, the data set comprises real-time sensor data of an environment perception data set processed via and/or utilized to train an associated updated individual model. In this regard, the central learning apparatus 250 may process and/or otherwise learn from some or all of the data set to train an updated central model as described herein.

At operation 1004, the central learning apparatus 250 includes means, such as the real-time central learning circuitry 262, the real-time model data intake circuitry 260, the communications circuitry 258, the input/output circuitry 256, the processor 252, and/or the like, or a combination thereof, to train an updated central model based at least in part on the received data set comprising the data embodying and/or associated with the plurality of updated individual models. In some embodiments, the central learning apparatus 250 maintains a central model, and retrieves the central model for updating. The central model may have been generated and/or updated at one or more previous operations (e.g., before or during operations of the process 1000).

The central learning apparatus 250 may process the received data set to train the updated central model based at least in part on data patterns, trends, and/or the like. For example, in some circumstances where the data set includes data embodying the plurality of updated individual models, the central learning apparatus 250 may train the updated central model by updating a central model based on parameters, hyperparameters, and/or other data of the updated individual model(s). In this regard, the updated central model may learn from the data learned by each of the updated individual models independently. Alternatively or additionally, in some circumstances where the data set includes error data object(s) associated with each of the plurality of updated individual models, the central learning apparatus 250 may train the updated central model to minimize the likelihood of producing an error represented by such error data object(s). Additionally or alternatively, in some circumstances where the data set includes at least a portion of an environment perception data set processed by and/or otherwise used to generate the updated individual models, and/or label data associated with such sensor data, the central learning apparatus 250 may train the updated central model based at least in part on such raw sensor data itself. Advantageously, in some embodiments, the central learning apparatus 250 utilizes the high-throughput communications network to enable real-time or near-real-time and/or continuous transmission of such a data set for use in training without sacrificing the data quality and/or high-fidelity nature of one or more portions of the data set, whereas conventional communications network may not be capable of enabling such real-time, near-real-time, and/or continuous transmission and instead would require batched and/or otherwise delayed updating.

At operation 1006, the central learning apparatus 250 includes means, such as the real-time central learning circuitry 262, the real-time model data intake circuitry 260, the communications circuitry 258, the input/output circuitry 256, the processor 252, and/or the like, or a combination thereof, to transmit the updated central model to one or more computing devices. In some embodiments, the central learning apparatus 250 maintains a connection with the plurality of individual computing devices (e.g., via a high-throughput communications network), and transmits the updated central model to each of the plurality of individual computing devices with which the central learning apparatus 250 maintains a connection. Alternatively or additionally, in some embodiments, the central learning apparatus 250 transmits the updated central model only to some or all of the plurality of individual computing devices from which data was received for use in generating the updated central model. In one example context, the central learning apparatus 250 transmits the updated central model to any number of AI robots with which the central learning apparatus 250 is connected and/or communicable. In another example context, the central learning apparatus 250 receives the data set comprising data embodying and/or associated with a plurality of updated individual models from certain AI robots, and transmits the updated central model only to each of those certain AI robots.

In some embodiments, the central learning apparatus 250 performs one or more determination(s) to determine which of the plurality of individual computing devices should be transmitted the updated central model. For example, the central learning apparatus 250 may receive or generate, and subsequently maintain, accuracy data associated with each of the plurality of individual computing devices. The accuracy data associated with an individual computing device may indicate the accuracy of the updated individual model utilized by the individual computing device. In some such embodiments, for each individual computing device of the plurality of individual computing devices, the central learning apparatus 250 determines a difference between accuracy data associated with an individual model maintained by said individual computing device and accuracy data determined, generated, and/or otherwise associated with the updated central model. In a circumstance where the difference between the accuracy for a particular individual model associated with a particular individual computing device and the accuracy for the updated central model satisfies an update threshold, the central learning apparatus 250 transmits the updated central model to the individual computing device. Additionally or alternatively, in some embodiments the central learning apparatus 250 subsequently updates the accuracy data associated with the individual computing device to the accuracy data associated with the updated central model. In other embodiments, the central learning apparatus 250 transmits the updated central model to each of the one or more computing devices at predefined timestamp intervals, after a maximum timestamp interval since a last update, and/or the like.

In some embodiments, the central learning apparatus 250 transmits the updated central model to a computing device to cause the computing device to automatically assign the updated central model as a preferred model (e.g., thereby replacing the updated individual model currently maintained by the computing device). Alternatively or additionally, in some embodiments, the central learning apparatus 250 transmits the updated central model to a computing device to cause the computing device to automatically process the updated central model and determine whether the updated central model should be assigned as the preferred model for said computing device. For example, in some embodiments, the central learning apparatus 250 transmits the updated central model to an individual computing device to automatically cause the individual computing device to compare accuracy data associated with the updated central model and the model currently assigned to the individual computing device as a preferred model (e.g., the updated individual model for that individual computing device). In some such embodiments, the central learning apparatus 250 may transmit accuracy data associated with the updated central model, and/or transmit determined accuracy data to the one or more computing devices. In some such embodiments, the central learning apparatus 250 generates the accuracy data associated with the updated central model based at least in part on a test data set stored by the central learning apparatus 250 (e.g., in one or more data repositories maintained by the central learning apparatus 250).

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML, page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. An apparatus comprising at least one processor and at least one memory, the at least one memory having computer-coded instructions stored thereon that, in execution with the at least one processor, cause the apparatus to:
receive an environment perception data set associated with one or more real-time sensors;
train an updated individual model based at least in part on the environment perception data set; and
transmit, to a central learning system via at least one high-throughput communications network, the updated individual model to cause the real-time data central learning system to update a central model based at least in part on the updated individual model.

2. The apparatus according to claim 1, wherein the first computing device receives the environment perception data set via the one or more high-throughput communications network.

3. The apparatus according to claim 1, the apparatus further caused to:
receive, from the real-time data central learning system, an updated central model trained based at least in part on the updated individual model and a plurality of other updated individual models associated with a plurality of other computing devices; and
replace the updated individual model with the updated central model.

4. The apparatus according to claim 1, wherein the one or more real-time sensors comprises a real-time video sensor, a real-time image sensor, a real-time motion sensor, a real-time location sensor, or a combination thereof.

5. The apparatus according to claim 1, the apparatus further configured to:
receive, from the real-time data central learning system, an updated central model trained based at least in part on the updated individual model and a plurality of other updated individual models associated with a plurality of other computing devices;
compare first accuracy data associated with the updated individual model and second accuracy data associated with the updated central model to determine a preferred model representing the updated individual model or the updated central model; and
apply a second environment perception data set to the preferred model.

6. The apparatus according to claim 1, the apparatus further configured to:
transmit error data objects associated with the training of the updated individual model to the real-time data central learning system.

7. The apparatus according to claim 1, wherein the one or more real-time sensors are each embodied within the first computing device.

8. The apparatus according to claim 1, wherein at least one of the one or more real-time sensors is external from the first computing device.

9. The apparatus according to claim 1, wherein the updated individual model embodies a reinforcement learning model.

10. A computer-implemented method comprising:
receiving, at a first computing device, an environment perception data set associated with one or more real-time sensors;
training, at the first computing device, an updated individual model based at least in part on the environment perception data set; and
transmitting, from the first computing device to a central learning system via at least one high-throughput communications network, the updated individual model to cause the real-time data central learning system to update a central model based at least in part on the updated individual model.

11. The computer-implemented method according to claim 1, wherein the first computing device receives the environment perception data set via the one or more high-throughput communications network.

12. The computer-implemented method according to claim 1, the computer-implemented method further comprising:
receiving, at the first computing device from the real-time data central learning system, an updated central model trained based at least in part on the updated individual model and a plurality of other updated individual models associated with a plurality of other computing devices; and
replacing the updated individual model with the updated central model.

13. The computer-implemented method according to claim 1, wherein the one or more real-time sensors comprises a real-time video sensor, a real-time image sensor, a real-time motion sensor, a real-time location sensor, or a combination thereof.

14. The computer-implemented method according to claim 1, the computer-implemented method further comprising:
receiving, at the first computing device from the real-time data central learning system, an updated central model trained based at least in part on the updated individual model and a plurality of other updated individual models associated with a plurality of other computing devices;
comparing first accuracy data associated with the updated individual model and second accuracy data associated with the updated central model to determine a preferred model representing the updated individual model or the updated central model; and
applying a second environment perception data set to the preferred model.

15. The computer-implemented method according to claim 1, the computer-implemented method further comprising:
transmitting error data objects associated with the training of the updated individual model to the real-time data central learning system.

16. The computer-implemented method according to claim 1, wherein the one or more real-time sensors are each embodied within the first computing device.

17. The computer-implemented method according to claim 1, wherein at least one of the one or more real-time sensors is external from the first computing device.

18. The computer-implemented method according to claim 1, wherein the updated individual model embodies a reinforcement learning model.

19. A computer program product comprising at least one non-transitory computer-readable storage medium having computer program code stored thereon, wherein the computer program code in execution with at least one processor configures the computer program product for:
receiving, at a first computing device, an environment perception data set associated with one or more real-time sensors;
training, at the first computing device, an updated individual model based at least in part on the environment perception data set; and
transmitting, from the first computing device to a central learning system via at least one high-throughput communications network, the updated individual model to cause the real-time data central learning system to update a central model based at least in part on the updated individual model.

20. The computer program product according to claim 19, the computer program product further configured for:
receiving, at the first computing device from the real-time data central learning system, an updated central model trained based at least in part on the updated individual model and a plurality of other updated individual models associated with a plurality of other computing devices; and
replacing the updated individual model with the updated central model.
